(19) United States
(12) Patent Application Publication
(10) Pub. No.: US 2026/0333420 A1
(43) Pub. Date: Oct. 22, 2026

(54) METHODS, SYSTEMS, AND APPARATUSES FOR INDICATION OF ACCESS POINT IDENTIFIERS (APIDS) FOR MULTI-ACCESS POINT COORDINATION (MAPC)

(71) Applicant: Nokia Technologies Oy, Espoo (FI)

(72) Inventors: Salvatore TALARICO, Sunnyvale, CA (US); Orhan Okan MUTGAN, Munich (DE); Mika KASSLIN, Espoo (FI); Klaus Franz DOPPLER, Albany, CA (US); Kerstin JOHNSSON, Palo Alto, CA (US); Mikhail LIUBOGOSHCHEV, Munich (DE)

(21) Appl. No.: 19/180,494

(22) Filed: Apr. 16, 2025

(51) Int. Cl. H04W 74/08; H04W 84/12

(52) U.S. Cl. CPC H04W 74/08; H04W 84/12

(57) ABSTRACT

Methods, apparatuses, and systems provide for indication of access point identifiers (APIDs) for multi-access point coordination (MAPC). In the context of a method, the method includes receiving, via a first primary channel of a basic service set (BSS) associated with an apparatus, a physical layer protocol data unit (PPDU) comprising information that indicates a plurality of APIDs of a plurality of access points (APs) operating in accordance with at least one MAPC scheme; and based at least in part on the plurality of APIDs, determining whether to operate on the first primary channel or a second primary channel, the second primary channel being associated with non-primary channel access (NPCA).

### TECHNOLOGICAL FIELD

Various aspects of the present disclosure relate generally to techniques for non-primary channel access (NPCA) and, more particularly, to a framework for simultaneous use of NPCA and multi-access point coordination (MAPC) schemes.

### BACKGROUND

Wireless communications systems, such as wireless fidelity (Wi-Fi) systems, may support non-primary channel access (NPCA) for Wi-Fi stations (STAs). In accordance with some NPCA designs, STAs may switch to an NPCA primary channel in response to a set of conditions being satisfied. In some cases, the set of conditions used by a STA for determining whether to switch to the NPCA primary channel may reduce resource utilization within the Wi-Fi system and constrain a performance of latency-sensitive applications at the STA.

### BRIEF SUMMARY

Methods, apparatuses, and systems are disclosed for indication of access point identifiers (APIDs) for MAPC. In this regard, the methods, apparatuses, and systems are configured to support a framework for simultaneous use of NPCA and MAPC. For example, the methods, apparatuses, and systems are configured to support joint operation of NPCA and one or more MAPC schemes. By providing for simultaneous use of NPCA and MAPC, the methods, apparatuses, and systems may reduce latency and improve resource utilization within a wireless communications system.

In at least one example embodiment, an apparatus is provided. The apparatus comprises at least one processor; and at least one memory storing instructions that, when executed by the at least one processor, cause the apparatus at least to: receive, via a first primary channel of a basic service set (BSS) associated with the apparatus, a physical layer protocol data unit (PPDU) comprising information that indicates a plurality of access point identifiers (APIDs) of a plurality of access points (APs) operating in accordance with at least one multi-access point coordination (MAPC) scheme; and based at least in part on the plurality of APIDs, determine whether to operate on the first primary channel or a second primary channel, the second primary channel being associated with non-primary channel access (NPCA).

In at least one example embodiment, determining whether to operate on the first primary channel or the second primary channel comprises: determining to operate on the first primary channel based at least in part on at least one APID of the plurality of APIDs being equal to an APID of an AP associated with the apparatus; or determining to operate on the second primary channel based at least in part on the plurality of APIDs being different from an APID of an AP associated with the apparatus.

In at least one example embodiment, the instructions, when executed by the at least one processor, cause the apparatus at least to: monitor for one or more initial control responses (ICRs) from an AP associated with the apparatus, wherein determining whether to operate on the first primary channel or the second primary channel is based at least in part on the monitoring.

In at least one example embodiment, the instructions, when executed by the at least one processor, cause the apparatus at least to: receive, from the AP via the first primary channel, an ICR associated with a transmission opportunity shared between the AP and at least one other AP in accordance with the at least one MAPC scheme; and determine to continue to operate on the first primary channel within the transmission opportunity based at least in part on the reception of the ICR and at least one APID of the plurality of APIDs being equal to an APID of the AP.

In at least one example embodiment, the instructions, when executed by the at least one processor, cause the apparatus at least to: determine to operate on the second primary channel outside of a transmission opportunity based at least in part on a failure to detect an ICR associated with the transmission opportunity and at least one APID of the plurality of APIDs being equal to an APID of the AP, wherein the transmission opportunity is shared between the AP and at least one other AP in accordance with the at least one MAPC scheme.

In at least one example embodiment, the APID is one of a second plurality of APIDs associated with the AP, and wherein each APID of the second plurality of APIDs is associated with a respective MAPC agreement between the AP and at least one other AP.

In at least one example embodiment, the apparatus comprises an AP or non-access point (non-AP) station (STA).

In at least one example embodiment, the AP or non-AP STA is capable of performing one or more NPCA operations.

In at least one example embodiment, a method is provided. The method comprises: receiving, via a first primary channel of a basic service set (BSS) associated with an apparatus, a physical layer protocol data unit (PPDU) comprising information that indicates a plurality of access point identifiers (APIDs) of a plurality of access points (APs) operating in accordance with at least one multi-access point coordination (MAPC) scheme; and based at least in part on the plurality of APIDs, determining whether to operate on the first primary channel or a second primary channel, the second primary channel being associated with non-primary channel access (NPCA).

In at least one example embodiment, a non-transitory computer readable storage medium is provided. The non-transitory computer readable storage medium comprises instructions that, when executed by an apparatus, cause the apparatus at least to: receive, via a first primary channel of a basic service set (BSS) associated with the apparatus, a physical layer protocol data unit (PPDU) comprising information that indicates a plurality of access point identifiers (APIDs) of a plurality of access points (APs) operating in accordance with at least one multi-access point coordination (MAPC) scheme; and based at least in part on the plurality of APIDs, determine whether to operate on the first primary channel or a second primary channel, the second primary channel being associated with non-primary channel access (NPCA).

In at least one example embodiment, determining whether to operate on the first primary channel or the second primary channel comprises: determining to operate on the first primary channel based at least in part on at least one APID of the plurality of APIDs being equal to an APID of an AP associated with the apparatus; or determining to operate on the second primary channel based at least in part on the plurality of APIDs being different from an APID of an AP associated with the apparatus.

In at least one example embodiment, an apparatus is provided. The apparatus comprises means for: receiving, via a first primary channel of a basic service set (BSS) associated with an apparatus, a physical layer protocol data unit (PPDU) comprising information that indicates a plurality of access point identifiers (APIDs) of a plurality of access points (APs) operating in accordance with at least one multi-access point coordination (MAPC) scheme; and based at least in part on the plurality of APIDs, determining whether to operate on the first primary channel or a second primary channel, the second primary channel being associated with non-primary channel access (NPCA).

The above summary is provided merely for purposes of summarizing at least some example embodiments to provide a basic understanding of some aspects of the disclosure. Accordingly, it will be appreciated that the above-described embodiments are merely examples and should not be construed to narrow the scope of the disclosure in any way. It will also be appreciated that the scope of the disclosure encompasses many potential embodiments in addition to those summarized here, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates an example communications system to which one or more examples disclosed herein may be applied;

FIG. 2A illustrates an example communications system to which one or more examples disclosed herein may be applied;

FIGS. 2B, 2C, 2D, and 2E illustrate example timing diagrams to which one or more examples disclosed herein may be applied;

FIGS. 3 through 5 illustrate example signaling diagrams to which one or more examples disclosed herein may be applied;

FIG. 6 illustrates an example block diagram of an apparatus to which one or more examples disclosed herein may be applied; and

FIG. 7 illustrates an example flowchart of a method to which one or more examples disclosed herein may be applied.

### DETAILED DESCRIPTION

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. Further, when a particular feature, structure, or characteristic is described in connection of an embodiment, it is within the knowledge of one skilled in the art to apply such feature, structure, or characteristic in connection with other embodiments whether or not explicitly described. It shall be understood that although the terms “first,” “second” and the like may be used herein to describe various elements, these elements should not be limited by these terms. These terms are only used to distinguish one element from another.

For the purposes of the present disclosure, the phrases “at least one of A or B”, “at least one of A and B”, and “A and/or B” means (A), (B), or (A and B). For the purposes of the present disclosure, the phrase “A, B, and/or C” means (A), (B), (C), (A and B), (A and C), (B and C), or (A, B, and C).

Embodiments described may be implemented in a communications system (e.g., a communication network), such as any of the following radio access technologies (RATs): wireless fidelity (Wi-Fi), BLUETOOTH, Worldwide Interoperability for Micro-wave Access (WiMAX), Global System for Mobile communications (GSM, 2G), GSM EDGE radio access Network (GERAN), General Packet Radio Service (GRPS), Universal Mobile Telecommunications system (UMTS, 3G) based on basic wideband-code division multiple access (W-CDMA), high-speed packet access (HSPA), Long Term Evolution (LTE), LTE-Advanced, and enhanced LTE (eLTE), 5G (also called NR), or any future radio access technology (RAT) such as 6G. Moreover, communication within the communication network may utilize any suitable wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiplexing (OFDM), and/or Discrete Fourier Transform spread OFDM (DFT-s-OFDM).

The term “terminal device” refers to any end device that may be capable of wireless communication. By way of example, a terminal device may be referred to as a communication device, user equipment (UE), a Subscriber Station (SS), a Mobile Station (MS). The terminal device may include a mobile phone, a cellular phone, a smart phone, voice over IP (VoIP) phones, wireless local loop phones, a tablet, a wearable terminal device, a personal digital assistant (PDA), portable computers, desktop computers, image capture terminal devices such as digital cameras, gaming terminal devices, music storage and playback appliances, vehicle-mounted wireless terminal devices, universal serial bus (USB) USB dongles, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like.

A term “resource”, as used herein, may refer to radio resources in time domain, in frequency domain, in space domain, and/or in code domain. Some examples of resources include e.g. a physical resource block (PRB), a radio frame, a subframe, a time slot, a subband, a frequency region, a sub-carrier, a beam, etc. The term “transmission” and/or “reception” may refer to wirelessly transmitting and/or receiving via a wireless propagation channel on radio resources.

In some examples, a communications system may be deployed in a wireless local area network (WLAN), such as a Wi-Fi network. That is, in some examples, a communications system may be an example of a WLAN system. The WLAN system may support wireless communications between one or more communications devices in accordance with one or more Wi-Fi protocols, such as protocols based on institute of electrical and electronics engineers (IEEE) 802.11 standards and/or related drafts, such as 802.11-2020, 802.11ac, 802.11ax, 802.11be, 802.11bn, and/or others.

In some examples, Wi-Fi communications may occur via one or more radio frequency bands, such as 2.4 gigahertz (GHz), 3.6 GHz, 5 GHz, 6 GHz, 60 GHz, and/or the like. In some such examples, each radio frequency band may support one or more channels (e.g., 20 megahertz (MHz) channels) over which data may be communicated. In some examples, multiple devices may use multiple channels to communicate over the WLAN simultaneously.

A WLAN system may include one or more communications devices, which are referred to herein as stations (STAs). A STA may be an access point (AP) and/or a non-AP STA. For example, a device configured to support one or more Wi-Fi protocols may be an example of an AP (e.g., may operate in accordance with an AP mode) and/or may be an example of a non-AP STA (e.g., may operate in accordance with a non-AP STA mode). In some examples, an AP may control Wi-Fi communications for one or more non-AP STAs. As such, a non-AP STA may also be referred to as a client. For example, an AP may be (or may be connected to) a central entity used to establish (and/or control) one or more connections between one or more non-AP STAs and another network (e.g., the Internet). In other words, in some examples, the AP may connect a wired network (e.g., the Internet) to a wireless network (e.g., the WLAN). In some instances, a Wi-Fi network may be identified via one or more identifiers, such as a service set identifier (SSID) or a basic service set identifier (BSSID).

In some examples, an AP of a WLAN system includes at least one distribution system access function configured to facilitate data communication beyond the AP. Additionally, or alternatively, non-AP STAs may be configured to be end devices, which rely on association with an AP to communicate with devices other than the AP. An AP may be configured to connect to a wired local area network (LAN) (e.g., via Ethernet). The AP may allow one or more client devices (e.g., non-AP STAs) to access wireless connections via WLAN. The client devices may also be referred to as “WLAN clients”. WLAN clients may comprise various devices and/or types of devices, including laptops, tablets, cell phones, and/or other devices.

A WLAN system may support one or more architectures (types of logical relationships between devices). For example, a WLAN system may support an autonomous architecture, a centralized architecture, a cooperative architecture, and/or other types of architectures. In some examples of an autonomous architecture, APs are stand-alone APs configured with features and capabilities to operate without any reliance on another device. In some examples of a centralized architecture, a centralized network manager may regulate the operation of the WLAN. In other words, the network manager may be the AP or may be connected to one or more APs within the WLAN. For example, APs may be connected (e.g., wirelessly and/or via a wired connection) to a central entity, which may be configured to act as a network manager. In some examples, the network manager is a cloud-based entity, which may reside either in a private cloud or in a public cloud. In some examples of a cooperative architecture (also referred to as a network manager-less or controller-less architecture), a virtual management (e.g., cloud-based) system may be used to control a WLAN. For example, the virtual management system may employ a cooperative communication method between one or more APs to control the WLAN. In other examples, a centralized network manager may use a wireless system to provide local connection to clients. For example, the centralized network manager may be a controller configured to perform operations related to authentication, authorization, accounting (e.g., via an authentication, authorizing, and accounting (AAA) server), and/or other operations.

Additionally, or alternatively, a WLAN system may support one or more topologies (types of physical connections between various devices within the WLAN system). For example, the WLAN system may support an infrastructure topology which may include a combination of wired and wireless connections. In some examples of an infrastructure topology, the infrastructure topology may include one or more wired devices with a wired connection to a network (e.g., one or more APs that are each connected via a cable to a switch) and the one or more wired devices may support one or more wireless connections to one or more wireless devices (e.g., laptops, tablets, cell phones), such that the wireless devices may connect wirelessly to the network. In other words, the one or more wired devices may serve as a bridge between the wireless network and the wired network. Additionally, or alternatively, the WLAN system may support an ad hoc topology, which does not rely on infrastructure (e.g., cables, routers, servers, or APs). In some examples of an ad hoc network, one or more clients may wirelessly connect to other devices in a peer-to-peer network. Additionally, or alternatively, the WLAN system may support a mesh topology in which multiple network devices are interconnected with each other via wireless connections. For example, in accordance with a mesh topology, an AP (e.g., each AP), which may support one or more wireless connections with one or more clients, may communicate wirelessly with one or more other APs.

In accordance with one or more Wi-Fi protocols, data may be transmitted wirelessly between two devices (e.g., an AP and a client) via packets, referred to as protocol data units (PDUs). In other words, Wi-Fi communications may include transmission and reception of one or more PDUs. For example, data may be communicated via a frame (e.g., a medium access control (MAC) frame), which may include one or more PDUs. In some instances, multiple frames may include the same PDU. In some examples, a PDU may include data (referred to as a payload), as well as one or more headers (e.g., a sequence of one or more fields) and/or one or more trailers (e.g., a sequence of bits appended to the PDU, after the payload). In some examples, the data included in the PDU, may be user data, control data, management data, and/or other types of data. In some examples, frames may include data type frames, control type frames, management type frames, and/or other types of frames. At least one frame type (e.g., each frame type) may be included in a PDU, wherein a payload of a PDU may comprise user data, control data, management data, and/or other data. In some examples, a WLAN system may implement one or more security protocols to protect the confidentiality, integrity, and availability of Wi-Fi communications.

In some examples, a WLAN system may support transmission opportunities (TXOPs) to increase throughput, such as for high priority data, by providing contention-free channel access for a period of time. A TXOP may be available in a quality of service (QoS) mode as part of Enhanced Distributed Channel Access (EDCA), and/or may be a limited time period of contention-free channel access available to the channel-owning station (e.g., the TXOP holder). During such a period a TXOP holder, which may be a non-AP STA or an AP, may send multiple frames that satisfy criteria, which may have been determined for the use of TXOP. In some examples, the criteria may allow transmission of frames belonging to an access category (AC) other than the AC for which the TXOP has been obtained. In some examples, a TXOP may increase throughput and/or reduce delay of QoS data frames by eliminating contention periods between transmissions. In some examples, a TXOP may be used in combination with frame aggregation and block acknowledgement to further increase throughput.

In some examples, access categories have different channel access parameters, such as Arbitration Interframe Spacing (AIFS), duration, contention window size, and TXOP limit. In some examples, values of these parameters may be set in a manner that increases a likelihood of higher priority packets being prioritized over lower priority packets. For example, the values of the parameters may be set that a non-AP STA (typically) waits for a shorter duration before sending the higher priority packets compared to a duration that the non-AP STA may wait before sending the lower priority packets. Additionally, or alternatively, the values of the parameters may be set so that the contention window for higher priority packets is smaller than that of lower priority packets and/or so that multiple packets may be sent in a TXOP. In some examples, a TXOP holder, which may be either a non-AP STA or an AP, may send frames to multiple recipients during a TXOP. In addition to QoS data frames, other frames may be exchanged during the TXOP, such as an acknowledgement (ACK), BlockAckReq/BlockAck frames, and/or other control and management frames.

In some examples, a WLAN system uses multi-link operation (MLO) to improve data transmission (e.g., via using multiple frequency bands for transmissions). In some examples, MLO further comprises various features, including simultaneous transmit and receive (STR), multi-channel multi-radio (MCMR), enhanced multi-AP roaming (E-MAR), non-simultaneous transmit and receive (NSTR), multi-link multi-radio (MLMR), and/or other features.

An AP that supports MLO may be referred to as an AP multi-link device (MLD). An MLO-capable client, for example, such as a non-AP STA, may be referred to as a non-AP MLD. Such a client device may have two or more non-AP STAs with which it may establish links to an AP MLD. A connection between a non-AP STA and AP may represent a link between an AP MLD and a non-AP MLD. In some examples, APs which do not support MLO may be multi-band APs which have two or more APs operating in different bands and/or channels. An AP may operate in one or more bands and/or channels and a client device may connect to the AP via one or more of the bands and/or channels. For example, a client device may associate with the AP in one of the channels. An AP MLD may operate as a multi-band AP, while providing means for a multi-link capable client (non-AP MLD) to simultaneously use two or more of its radios and/or APs for communication with a single association. An AP MLD may be an MLMR, which is configured to communicate simultaneously with its APs with associated non-AP MLDs. Non-AP MLDs may have constraints (e.g., NSTR), which may indicate that simultaneous communication over established links is not possible. Therefore, in some such instances, a non-AP MLD may associate to an AP MLD. Accordingly, the non-AP MLD may be associated over two or more bands and/or channels and may communicate with the APs affiliated to the AP MLD over the established links.

WLAN devices configured with STR may be configured to allow simultaneous transmission and/or reception via different respective frequency bands, which may reduce latency. WLAN devices configured with MCMR may be configured to allow data transmission via two or more radios and/or channels, which may increase efficiency, reduce congestion, and/or increase network speeds. WLAN devices configured with enhanced multilink single-radio (EMLSR) may be configured to allow client devices to switch between multiple respective APs while maintaining their connections, which may allow more consistent connectivity. WLAN devices configured with NSTR may be configured to allow client devices to non-simultaneous transmission and/or reception via different respective frequency bands, which may reduce latency (particularly in comparison with single-link operation). WLAN devices configured with MLMR may be configured to allow different respective radios and/or channels to be used for managing respective links, which may reduce interference and/or improve network performance.

A WLAN system may be configured with various types of services sets, for example, such as basic service set (BSS) and/or an extended service set (ESS). A BSS may be comprised of an AP and one or more client devices (e.g., non-AP STAs) associated with the AP. The one or more client devices may have one or more common physical layer (PHY) medium access characteristics (e.g., radio frequency, modulation scheme, security settings, and/or the like). A BSSID may define the BSS such that the one or more client devices of the BSS share the same BSSID.

In some examples, two or more BSSs may have overlapping coverage areas, and they may operate with either partially or entirely same radio frequency channels. In such examples of overlapping BSSs (OBSSs), a client device may transmit frames from the area of overlap, and one or more other client devices may sense the transmission. Responsive to sensing the transmission, the one or more other client devices may cease their own transmissions. In some examples, if the other client devices do not sense the transmission, the other client devices may become hidden terminals with respect to the client device which is transmitting.

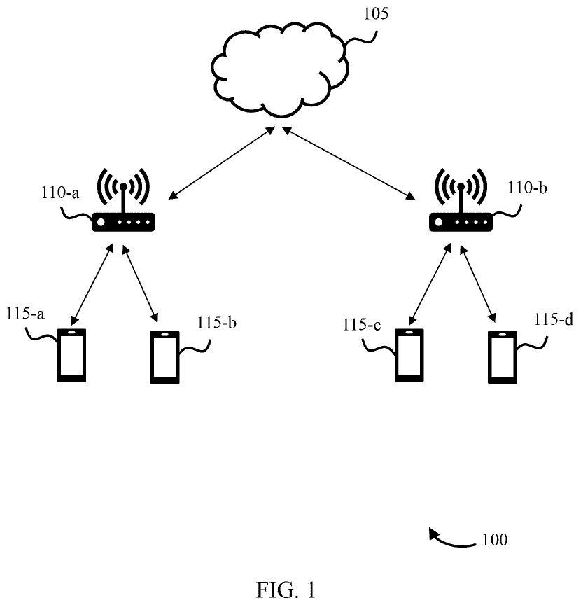

FIG. 1 illustrates an example communications system 100 to which one or more examples disclosed herein may be applied. The communications system 100 may include a cloud network 105, one or more APs (e.g., an AP 110-a, an AP 110-b), and one or more client devices connected to the one or more APs. A client device is also referred to herein as a non-AP STA. The communications system 100 may include a client 115-a and a client 115-b connected to the AP 110-a, as well as a client 115-c and a client 115-d connected to the AP 110-b. In some examples, the APs 110 may be mobile access points (mAPs) with constrained functionality. In some such examples, a configuration comprising an mAP and a client may be implemented as part of a peer-to-peer connection, for example, as in Wi-Fi Direct or Wi-Fi Aware. In some examples, a device may simultaneously operate as a client and as an AP. One such an example case is in a multi-AP network, which includes two or more devices that may act as APs and use Wi-Fi for the wireless backhaul connectivity based on a client-AP connection model.

In some wireless communications systems, APs may provide wireless connectivity for one or more clients according to the Wi-Fi standards, such as those that are a subset of the IEEE 802 family of standards. For example, the MAC and PHY specifications for Wi-Fi access points are defined by IEEE 802.11 for transmitting and receiving data in frequency bands such as 2.4 GHz, 3.6 GHz, 5 GHz, 6 GHz, 60 GHz, and/or the like. APs and clients may communicate through the transmission of frames, including data frames, management frames, and/or control frames, which may be transmitted in unicast messages, broadcast messages, or multicast messages. The 802.11 standards define an inter-frame space (IFS) as the nominal time (in microseconds (μs)) that the MAC and PHY use to receive the last symbol of a frame, process the frame, and respond with the first symbol of a response frame (e.g., the earliest possible response frame).

In the example of FIG. 1, the clients 115 may be configured to be in a wireless connection with at least one Wi-Fi AP (e.g., the APs 110). Functionalities of the at least one Wi-Fi AP may be implemented by various entities and/or types of entities, for example, such as APs, mAPs, access nodes, nodes, hosts, servers, base stations, and/or other entities suitable for such usage. Functionalities of the at least one client device may be implemented by various entities and/or types of entities, for example, such as clients-side user devices, non-AP STAs, UEs, and/or other entities suitable for such usage. For example, the communications system 100 may support radio frequency sensing during IFS.

The communications system 100 may support one or more frameworks for simultaneous use of NPCA and MAPC schemes, in accordance with one or more aspects of the present disclosure. By supporting the one or more frameworks, the communications system 100 may improve resource utilization and reduce latency within the communications system 100.

For example, the communications system 100 may support a framework for a common MAPC BSS color that enables simultaneous use of NPCA and MAPC schemes within the communication system 100. In accordance with the framework, a STA may receive a PPDU comprising a bit field pertaining to at least one BSS color associated with the PPDU. In response to receiving the PPDU, the STA may determine whether the PPDU is an inter-BSS PPDU (e.g., a PPDU from a different BSS with which the BSS of the STA has no MAPC agreement in place) or an intra-BSS PPDU (e.g., a PPDU from a different BSS with which the BSS of the STA has a MAPC agreement in place and/or a MAPC scheme is currently in use) based at least in part on the bit field.

Additionally, or alternatively, the communication system 100 may support a framework for indication of APIDs for MAPC that enables simultaneous use of NPCA and MAPC schemes within the communication system 100. In accordance with the framework, a STA may receive, via a first primary channel of a BSS associated with the STA, a PPDU comprising information that indicates multiple APIDs of multiple APs operating in accordance with at least one MAPC scheme. In response to receiving the PPDU, and based on the multiple APIDs, the STA may determine whether to operate on the first primary channel or a second primary channel, where the second primary channel is associated with NPCA (e.g., the secondary primary channel is an NPCA primary channel).

Additionally, or alternatively, the communication system 100 may support a framework for MAPC that enables simultaneous use of NPCA and MAPC schemes within the communication system 100. The framework for MAPC may include a non-AP STA using BSS colors and/or APIDs to determine whether to utilize MAPC or NPCA. In accordance with the framework, the non-AP STA may determine information that indicates multiple identifiers associated with multiple APs configured to operate in accordance with a MAPC scheme during at least a transmission opportunity, where the multiple identifiers comprise multiple BSS colors or multiple APIDs. Based on the multiple identifiers, the non-AP STA may determine whether to operate on a first primary channel associated with a BSS including the non-AP STA or a second primary channel, in which the second primary channel is associated with NPCA (e.g., the secondary channel is an NPCA primary channel).

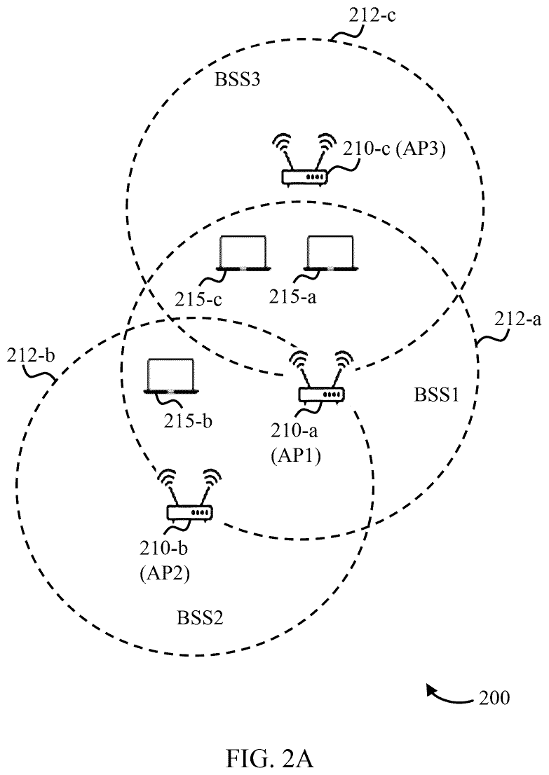

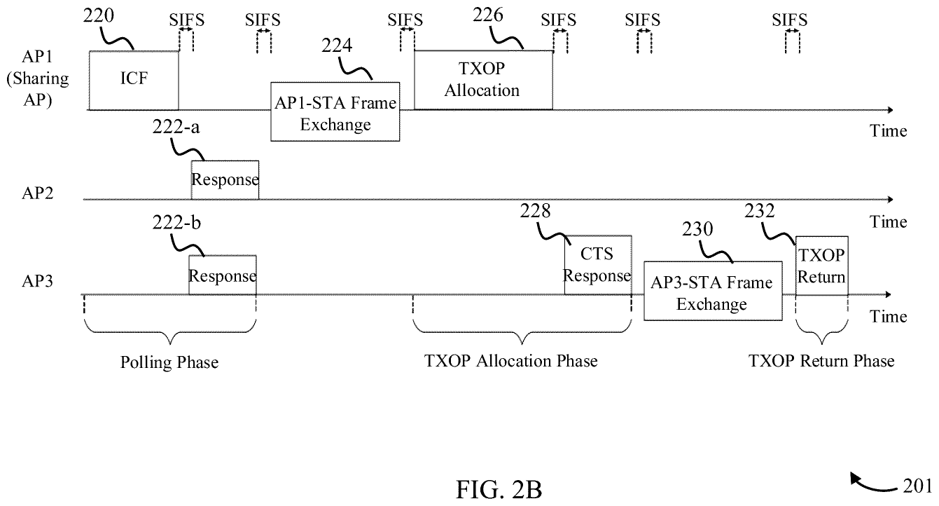

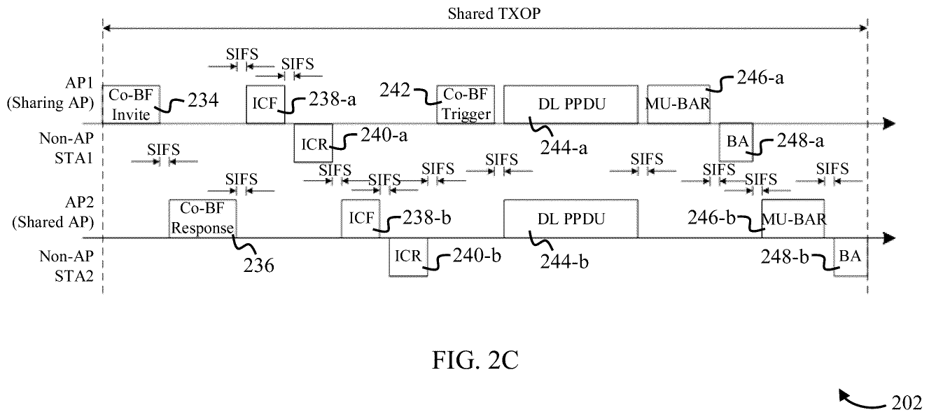

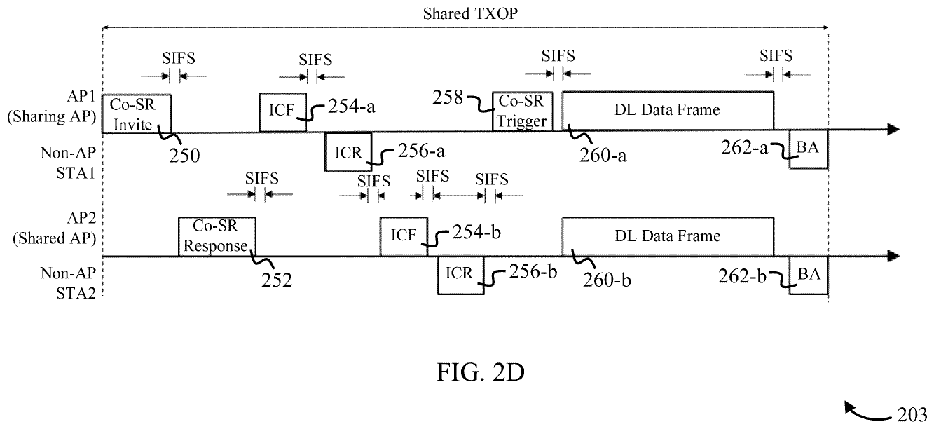

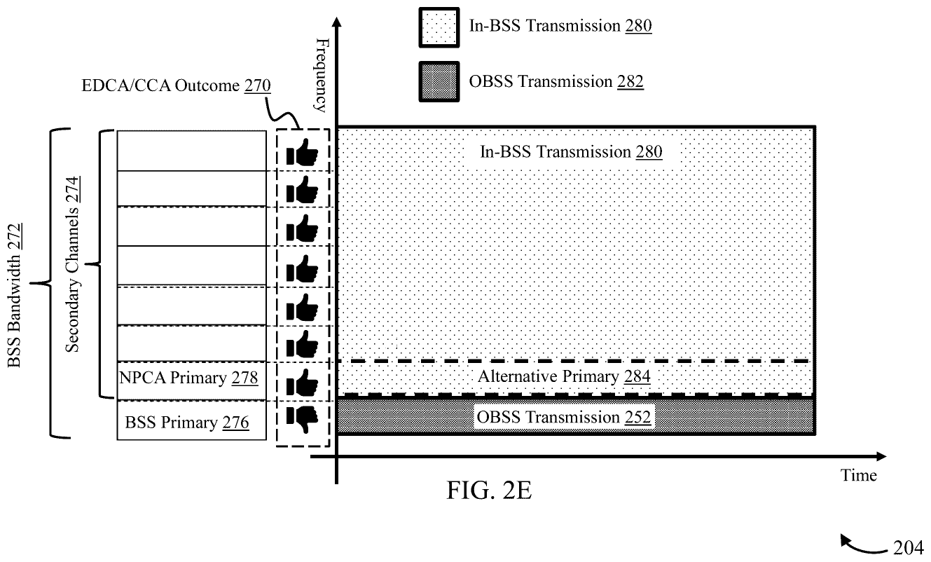

FIG. 2A illustrates an example communications system 200 to which one or more examples disclosed herein may be applied. The communications system 200 may be an example of a communications system illustrated by and described with reference to FIG. 1. For example, the communications system 200 may include APs 210 and clients 215 (e.g., non-AP STAs) connected to the APs 210. As illustrated in the example of FIG. 2A, the communications system 200 may include an AP 210-a (AP1) providing a coverage area 212-a, an AP 210-b (AP2) providing a coverage area 212-b, and an AP 210-c (AP3) providing a coverage area 212-c. The APs 210 may be examples of an AP illustrated by and described with reference to FIG. 1. The communications system 200 also includes a client 215-a, a client 215-b, and a client 215-c. The clients 215 may be examples of a non-AP STA illustrated by and described with reference to FIG. 1. In the example of FIG. 2A, the AP 210-a may be connected to the client 215-a (e.g., the AP 210-a and the client 215-a may be included in BSS1), the AP 210-b may be connected to the client 215-b (e.g., the AP 210-b and the client 215-b may be included in BSS2), and the AP 210-c may be connected to the client 215-c (e.g., the AP 210-c and the client 215-c may be included in BSS3).

In some examples, the communications system 200 may support one or more MAPC schemes. For example, the communications system 200 may support coordinated beamforming (Co-BF), coordinated spatial reuse (Co-SR), and coordinated time division multiple access (Co-TDMA). In MAPC schemes (e.g., Co-BF, Co-SR, and Co-TDMA), two or more APs may share a TXOP. For example, an AP (referred to as a sharing AP) that has obtained a TXOP may share the TXOP with one or more other APs (referred to as shared APs). In the example of FIG. 2A, the AP 210-a (AP1) may be an example of a sharing AP, while the AP 210-b (AP2) and the AP 210-c (AP3) may be examples of a shared AP.

With the Co-BF MAPC scheme, two APs (a sharing AP and a shared AP) may transmit simultaneously to non-AP STAs by using beamforming across BSSs to place nulls to selected non-AP STAs in the other BSS. For example, the shared AP may transmit across both the BSS of the shared AP and the BSS of the sharing AP, and may use beamforming to place nulls to non-AP STAs in the BSS of the sharing AP. Simultaneously, the sharing AP may transmit across both the BSS of the sharing AP and the BSS of the shared AP, and may use beamforming to place nulls to non-AP STAs in the BSS of the shared AP. As illustrated in the example of FIG. 2A, the AP 210-a may share a TXOP with AP 210-b. In such an example, using Co-BF, AP 210-a (e.g., the sharing AP) may transmit across both BSS1 and BSS2, and may use beamforming to place nulls to the client 215-b. Simultaneously, AP 210-b (e.g., the sharing AP) may transmit across both BSS1 and BSS2, and may use beamforming to place nulls to the client 215-a.

With the Co-SR MAPC scheme, two (or more) APs may transmit simultaneously at the TXOP level to associated non-AP STAs by constraining the transmit power used by the APs within a shared portion of the TXOP to one or more levels, which allows simultaneous communication in the two (or more) BSSs. With the Co-TDMA MAPC scheme, a shared AP may be given an opportunity by a sharing AP to communicate with associated non-AP STAs during a part of the TXOP obtained by the shared AP.

In one or more MAPC schemes, the AP that has obtained a TXOP has an opportunity to approach one or more other APs with which the AP has agreed to use at least one of the MAPC schemes. For example, the AP 210-a may have a MAPC agreement with AP 210-b. In such an example, AP 210-a may obtain a TXOP and may offer the AP 210-b an opportunity to use at least a portion of the TXOP in accordance with at least one of the MAPC schemes covered by the MAPC agreement.

In some examples, the AP that has obtained a TXOP may indicate to those one or more APs that the TXOP is available for joint use per one or more scheme specific rules and conditions. According to some MAPC designs, the AP with the TXOP may transmit an initial control frame (ICF) which may be, as an example, a trigger frame (e.g., BSRP, multi-user request to send (MU-RTS)). That is, in some examples, an AP with a TXOP may poll other AP(s) via trigger-based-PPDU ((TB)-PPDU) to check whether the AP(s) are interested in using at least part of the TXOP. In some examples, a Multi-User Request-to-Send TXOP Sharing (MU-RTS TXS) trigger frame is used to share portion of the TXOP with another AP. In some such examples, an AP identifier (APID) of the AP receiving a portion of the TXOP is carried in an association ID (AID) field of the MU-RTS TXS trigger frame.

In some examples, an ICF may be sent at the beginning of the TXOP. The ICF may include an identifier of the AP (e.g., a user info field and AID12 subfield), which is proposed to become the shared AP. The ICF may include one or more other identifiers. For example, the ICF may include identifiers of the non-AP STAs connected to the sharing AP and an identifier of the MAPC scheme proposed for the TXOP. Once a proposed shared AP receives the ICF, the proposed shared AP may be provided with a means to either accept the proposal or decline the proposal. In some instances, the proposed shared AP may (e.g., is expected to) respond to the ICF indicating, as an example, whether the proposal is accepted or not. For example, AP(s) interested in using at least part of the TXOP may respond to the sharing AP through an Initial Control Response (ICR). In some examples, the AP that receives a portion of the TXOP may return one or more remaining portions of the TXOP (if any) through a TXOP return frame. In some of the MAPC schemes, no response from the proposed shared AP is not expected (or even possible). There might be, as an example, an implicit or explicit agreement between the two APs that whenever one of the APs receives an ICF from the other AP, the APs use one of the agreed MAPC schemes for the TXOP.

FIG. 2B illustrates an example timing diagram 201 to which one or more examples disclosed herein may be applied. The example timing diagram 201 illustrates an exemplary case of Co-TDMA. Although the operations illustrated in the example of FIG. 2B are illustrated in the context of Co-TDMA, one or more of the operations may be applicable to one or more other MAPC schemes. The timing diagram 201 may be implemented at the APs 210 (e.g., AP1, AP2, and AP3) illustrated by and described with reference to FIG. 2A. As illustrated in the example of FIG. 2B, AP1 may be an example of a sharing AP. For example, at 220, during a polling phase, AP1 may transmit an ICF to AP2 and AP3. In response to the ICF, AP2 and AP3 may transmit a response to AP1 at 222-a and 222-b, respectively. At 224, AP1 may exchange one or more frames with one or more clients connected to AP1 (e.g., client 215-a). At 226, after the frame exchange(s) between AP1 and its client(s), AP1 may perform a TXOP allocation to AP3 using, for example, an MU-RTS TXS trigger frame. The TXOP allocation may occur during a TXOP allocation phase. At 228, during the TXOP allocation phase, AP3 may transmit a clear to send (CTS) response to AP1. At 230, AP3 may use a portion of the TXOP obtained (and shared) by AP1 to exchange one or more frames with a client of AP3 (e.g., client 115-c). At 232, after the frame exchange(s) between AP3 and its client(s), AP3 may return the TXOP to AP1 (e.g., during a TXOP return phase).

FIG. 2C illustrates an example timing diagram 202 to which one or more examples disclosed herein may be applied. The example timing diagram 202 illustrates an exemplary case of Co-BF. Although the operations illustrated in the example of FIG. 2C are illustrated in the context of Co-BF, one or more of the operations may be applicable to one or more other MAPC schemes. The timing diagram 202 may be implemented at the APs 210 (e.g., AP1 and AP2) illustrated by and described with reference to FIG. 2A. As illustrated in the example of FIG. 2C, AP1 may be an example of a sharing AP and AP2 may be an example of a shared AP.

For Co-BF, during a shared TXOP, a sharing and shared AP may exchange a Co-BF invite and response that initiate a sequential ICF/ICR exchange between an AP and its associated non-AP STAs for one or more coordinating APs (e.g., all coordinating APs) starting from the sharing AP. In other words, to initiate a sequential ICF/ICR exchange between a coordinating AP and an associated non-AP STA, the coordinating AP (one of the sharing or shared AP) may exchange a Co-BF invite and Co-BF response with another coordinating AP (the other of the sharing or shared AP).

For example, at 234, AP1 may transmit a Co-BF invite to AP2. In response, at 236, AP2 may transmit a Co-BF response to AP1. After AP1 and AP2 exchange the Co-BF invite and response, AP1 and AP2 may exchange ICFs and ICRs with one or more associated non-AP STAs. For example, at 238-a, AP1 may transmit an ICF to non-AP STA1. Additionally, at 238b, AP2 may transmit an ICF to non-AP STA2. At 240-a, in response to the ICF from AP1, non-AP STA 1 may transmit an ICR to APL. Additionally, at 240-b, in response to the ICF from AP2, non-AP STA2 may transmit an ICR to AP2. The ICF/ICR exchange between AP1 and non-AP STA1 may occur prior to the ICF/ICR exchange between AP2 and non-AP STA2 based on AP1 being the sharing AP and AP2 being a shared AP.

The sharing AP may transmit a dedicated Co-BF trigger frame that signals the start of one or more DL PPDU transmissions. For example, at 242, AP1 may transmit a Co-BF trigger frame to AP2 to signal the start of a DL PPDU transmission from AP1 at 244-a and/or the start of a DL PPDU transmission from AP2 at 244-b. DL data transmission(s) within the shared TXOP may terminate with a sequential transmission of a multi-user block acknowledgment request (MU-BAR) and a block acknowledgment (BA) from an AP and its associated non-AP STAs for one or more coordinating APs (e.g., all coordinating APs) starting with the sharing AP. In other words, to terminate one or more DL data transmission(s) within a shared TXOP, the coordinating AP and the associated non-AP STA may exchange an MU-BAR and a BA. For example, to terminate the DL PPDU transmission at 244-a, AP1 and non-AP STA1 may exchange a MU-BAR and a BA at 246-a and 248-a, respectively. Additionally, to terminate the DL PPDU transmission at 244-b, AP2 and non-AP STA2 may exchange a MU-BAR and a BA at 246-b and 248b, respectively.

FIG. 2D illustrates an example timing diagram 203 to which one or more examples disclosed herein may be applied. The example timing diagram 203 illustrates an exemplary case of Co-SR. Although the operations illustrated in the example of FIG. 2D are illustrated in the context of Co-SR, one or more of the operations may be applicable to one or more other MAPC schemes. The timing diagram 203 may be implemented at the APs 210 (e.g., AP1 and AP2) illustrated by and described with reference to FIG. 2A. As illustrated in the example of FIG. 2D, AP1 may be an example of a sharing AP.

For Co-SR, during a shared TXOP, a sharing AP and shared AP may exchange Co-SR invite and response frames, which initiate a sequential ICF/ICR exchange between an AP and its associated non-AP STAs for one or more coordinating APs (e.g., all coordinating APs) starting with the sharing AP. In other words, to initiate a sequential ICF/ICR exchange between a coordinating AP and an associated non-AP STA, the coordinating AP (one of the sharing or shared AP) may exchange a Co-SR invite and Co-SR response with another coordinating AP (the other of the sharing or shared AP).

For example, at 250, AP1 may transmit a Co-SR invite. Additionally, at 252, AP2 may transmit a Co-SR response. After AP1 and AP2 exchange the Co-SR invite and response, AP1 and AP2 may exchange ICFs and ICRs with one or more associated non-AP STAs. For example, at 254-a, AP1 may transmit an ICF to non-AP STA1. Additionally, at 254-b, AP2 may transmit an ICF to non-AP STA2. At 256-a, in response to the ICF from AP1, non-AP STA 1 may transmit an ICR to AP1. Additionally, at 256-b, in response to the ICF from AP2, non-AP STA2 may transmit an ICR to AP2.

A sharing AP may transmit a dedicated Co-SR trigger frame that signals the start of one or more DL PPDU transmissions. For example, at 258, AP1 may transmit a Co-SR trigger frame to AP2 to signal the start of a DL PPDU transmission from AP1 at 260-a and/or the start of a DL PPDU transmission from AP2 at 260-b. DL data transmission(s) within the shared TXOP may terminate with BAs from associated non-AP STAs. For example, at 262-a, non-AP STA1 may transmit a BA (to AP1) to terminate the DL PPDU transmission at 260-a. Additionally, at 262-b non-AP STA2 may transmit a BA (to AP2) to terminate the DL PPDU transmission at 260-b.

In some examples, the communications system 200 may support latency-sensitive applications at Wi-Fi devices (e.g., APs, non-AP STAs). Some such applications may include for example virtual reality (VR) applications, mixed reality (MR) applications, augmented reality (AR) applications, and extended reality (XR) applications. In some cases, reliability and non-deterministic channel access, such as for wideband transmissions, may constrain a performance of latency-sensitive applications. For example, a BSS may be configured with a primary 20 MHz channel to communicate various types of frames, such as beacon frames, management/control frames, action frames and/or data frames. For a wideband transmission (or channel bonding), a device may use the primary 20 MHz channel to communicate control frames and management frames (e.g., an ICF), and may communicate data frames by bonding the primary 20 MHz with one or more other available 20 MHz channels. The primary 20 MHz channel may be referred to as a BSS primary channel, a reference primary channel or, more simply, a primary channel. The one or more other available 20 MHz channels may be referred to as secondary channels. Channel bonding may provide for transmissions over multiple contiguous 20 MHz channels. In some instances, channel bonding may support transmissions over a total bandwidth of 40 MHz, 80 MHz, 160 MHz, or 320 MHz.

In some examples, if a device assesses the BSS primary channel to be idle, the device may perform a wideband transmission across a bandwidth including the BSS primary channel or the BSS primary channel and one or multiple contiguous secondary channels (e.g., totaling 40 MHz, 80 MHz, or 160 MHz or 320 MHz). In some instances, however, an OBSS transmission may overlap (partially or fully) with the BSS primary channel. In some such instances, the device may determine that the BSS primary channel is busy and, as such, may defer the wideband transmission. Consequently, the secondary channels may sit idle until the BSS primary channel is available, which may lead to reduced performance, for example, for latency-sensitive applications.

Some wireless communications systems may employ one or more protocols to reduce latency for devices, such as STAs running latency-sensitive applications (e.g., VR, MR, AR, and/or XR applications). In some cases, however, a wireless communications system may experience constrained reliability and non-deterministic channel access, such as for wideband transmissions. For example, when a device uses a wideband transmission (or channel bonding), the device may perform a listen-before-talk (LBT) procedure on each 20 MHz channel comprising the overall bandwidth used in the transmission. When operating in this mode, the device may select one of the 20 MHz channels as the primary channel. The selected channel may then be used as the primary channel (e.g., a reference primary channel) to communicate control frames (e.g., critical control frames) and management frames, as well as to support various types of STAs (e.g., legacy STAs, modern STAs), while data frames may be transmitted across the entire bandwidth (BW) by bonding the primary 20 MHz channel with other available secondary channels (e.g., all other available 20 MHz channels). For a device, such as a STA (e.g., an AP or non-AP STA), to acquire a TXOP and perform a wideband transmission, the device first gains access to (e.g., “wins”) the primary channel via an Enhanced Distributed Channel Access (EDCA) procedure. While the device may perform a separate check to determine whether a secondary channel is idle, the device may perform the EDCA procedure to “win” the primary channel irrespective of whether one or more secondary channels are idle. The separate check may be performed via a point coordination function (PCF) interframe space (PIFS) clear channel assessment (CCA).

In some examples, the device (a STA) may adjust a transmission bandwidth of the STA per TXOP to include 20 MHz, 40 MHz, 80 MHz, or 160 MHz based on channel availability. In some examples, however, the adjustment to the transmission bandwidth may be contingent upon the resulting bandwidth being contiguous, and the primary channel being assessed to be idle. For example, the STA may adjust the transmission bandwidth of the STA per TXOP to include 20 MHz, 40 MHz, 80 MHz, or 160 MHz based on channel availability so long as the resulting bandwidth is contiguous, and the primary channel was assessed to be idle. In some cases, however, such constraints may result in a substantial amount of unused spectrum, as some non-contiguous 20 MHz channels may be available, but sit idle due to the STA being constrained to using contiguous channels and/or the primary channel being occupied. Given an increasing amount of spectrum available for wireless transmissions (e.g., 802.11 transmissions), necessitating that the STA first capture the primary channel may lead to relatively large portions of the spectrum going unused. Consequently, the primary channel may represent a bottleneck in terms of system performance and spectrum utilization.

Constraints caused from necessitating the device first gain access to the BSS primary channel, may increase a complexity associated with provisioning resource and assigning neighboring BSSs non-overlapping primary channels in Wi-Fi deployments. Additionally, in some instances, such constraints may preclude a device from having relatively high bandwidth support (as relatively high bandwidths may have an increased likelihood of overlapping a neighboring primary channel). Such constraints may therefore result is an inefficient use of the available spectrum resources and an ineffective system throughput. Moreover, constraints caused from necessitating the device first gain access to the BSS primary channel, may be exacerbated by increases in an operating bandwidth (e.g., a maximum operating bandwidth) with subsequent Wi-Fi generations.

To address these primary channel constraints, the communications system 200 may support non-primary channel access (NPCA), in which a Wi-Fi device may switch from a BSS primary channel to another alternative channel (referred to herein as an NPCA primary channel) for contention to obtain a TXOP when the device determines that the BSS primary channel occupied. NPCA allows the device to look for a TXOP by contending in the NPCA primary channel instead of waiting for the BSS primary channel to become available before resuming contention in the BSS primary channel. In other words, NPCA enables a Wi-Fi device to (temporarily) switch its primary channel to another alternative channel for contention to obtain a TXOP when the device detects that the primary channel is occupied. NPCA therefore allow the device to look for a TXOP by contending in the other channel, which may be referred to as an NPCA primary channel, instead of waiting for the primary channel to become available before resuming contention in that primary channel. In some examples, the communications system 200 may support NPCA and one or more MAPC schemes, such as Co-BF, Co-SR, and/or Co-TDMA.

FIG. 2E illustrates an example timing diagram 204 to which one or more examples disclosed herein may be applied. The timing diagram 204 may be implemented at the APs 210 (e.g., AP1, AP2, and AP3) and/or the clients 215 illustrated by and described with reference to FIG. 2A. For example, AP1 and client 215-a may be associated with a first BSS (BSS1) having a BSS bandwidth 272 (also referred to as reference bandwidth). The BSS bandwidth 272 may include multiple channels (e.g., multiple 20 MHz channels). To perform a wideband transmission using some (or all) of the BSS bandwidth 272, client 215-a may perform an LBT procedure (e.g., an EDCA or CCA procedure) on one or more of the 20 MHz channel. In some instances, one of the channels may be selected as a BSS primary channel, which is used by AP1 and client 215-a as the reference channel to communicate control frames and management frames between client 215-a and AP1. As illustrated in the example of FIG. 2E, a first 20 MHz channel (BSS primary channel 276) may be selected as the BSS primary channel. In some such examples, client 215-a may transmit data frames across multiple channels (e.g., the entire bandwidth) by bonding the BSS primary channel 276 with one or more other available secondary channels 274. In some examples, however, for client 215-a to acquire a TXOP and perform a wideband transmission, client 215-a may first gain access to the BSS primary channel 276 (e.g., via an EDCA procedure). That is, if client 215-a fails to capture the BSS primary channel 276, client 215-a may refrain from performing the wideband transmission irrespective of whether one or more secondary channels 274 are idle. In some instances, client 215-a may gain access to a channel (e.g., the BSS primary channel 276 and/or one or more of the secondary channels 274) via a PIFS CCA procedure. In other words, client 215-a may perform an EDCA and/or CCA procedure to gain access to one or more channels of the BSS bandwidth 272 for an In-BSS transmission 280. For example, if an EDCA/CCA outcome 270 for a channel is positive (illustrated with a thumbs-up icon), client 215-a may determine that the channel is available (e.g., idle). Additionally, if an EDCA/CCA outcome 270 for a channel is negative (illustrated with a thumbs-down icon), client 215-a may determine that the channel is unavailable (e.g., busy, occupied).

As illustrated in the example of FIG. 2E, the client 215-a may be NPCA capable. NPCA may enable the client 215-a to (temporarily) utilize an alternative channel as a primary channel, referred to herein as an NPCA primary channel, when the BSS primary channel is occupied by an OBSS transmission or is otherwise unavailable. In other words, to increase spectrum utilization, one or more devices (e.g., client 215-a and/or AP1) may be configured to support NPCA. NPCA may enable the device(s) to utilize a secondary channel as an NPCA primary channel for instances in which the BSS primary channel is occupied due to OBSS traffic or is otherwise unavailable. As illustrated in the example of FIG. 2E, an OBSS transmission 282 may occupy the BSS primary channel 276 and, as such, the client 215-a may use an NPCA primary channel 278 (e.g., one of the secondary channels 274) as an alternative primary channel 284 for an In-BSS transmission 280. The client 215-a may access a secondary channel when the BSS primary channel is known to be busy due to OBSS traffic or other conditions and determines that one of the secondary channels 274 is idle and may be used as the alternative primary channel 284.

In accordance with some NPCA designs, NPCA may be enabled by an AP (for the BSS of the AP). Additionally, once the NPCA is enabled for the BSS, the AP and NPCA capable non-AP STAs of the BSS may switch to the NPCA primary when one or more conditions are satisfied. For example, the AP and NPCA capable non-AP STAs of the BSS may switch to the NPCA primary when the STA receives a PPDU and/or a PHY-RXSTART.indication primitive for an HE/EHT/UHR PPDU on the BSS primary channel and the following conditions are true: (a) the PPDU is classified by the STA as an inter-BSS PPDU (e.g., following the procedure defined in 26.2.2 for intra-BSS and inter-BSS PPDU classification); (b) the duration of the PPDU, (determined by the MAC, but necessarily involving some of the parameters of the RXVECTOR associated with the received PPDU) or the duration of the PPDU plus the value of the RXVECTOR parameter TXOP_DURATION of the PPDU, is greater than the value indicated in the most recently received or transmitted NPCA minimum duration threshold field corresponding to the BSS of which it is a member (the RXVECTOR parameter TXOP_DURATION of the PPDU may be considered for this comparison and it may be indicated by the AP); and (c) the 20/40/80/60 MHz channel occupied by the PPDU is identified by the STA, based on the bandwidth field in the PHY preamble of the PPDU and the channel allocations in the corresponding band, and the channel occupied by the PPDU does not overlap with the NPCA primary channel.

Additionally, or alternatively, the AP and NPCA capable non-AP STAs of the BSS may switch to the NPCA primary when the STA receives a PPDU including an initial response frame of a control frame exchange on the BSS primary channel and the following conditions apply: (a) the received PPDU(s) are classified by the STA as inter-BSS PPDU(s) (e.g., following the procedure defined in 26.2.2 for intra-BSS and inter-BSS PPDU classification); (b) the TXOP duration, determined from the duration field of the received frame(s), is greater than the value indicated in the most recently received or transmitted NPCA minimum duration threshold field corresponding to the BSS of the STA (the RXVECTOR parameter TXOP_DURATION of the received PPDU(s) may be considered for this comparison); and (c) the 20/40/80/60 MHz channel occupied by the received PPDU(s), identified by the STA based on the channel allocations in the corresponding band and the PPDU bandwidth that is signaled in the received PPDU(s) or obtained from the RXVECTOR parameter CH_BANDWIDTH_IN_NON_HT of the received PPDU(s), does not overlap with the NPCA primary channel (if the control frame is a request to send (RTS) frame in a non-HT (duplicate) PPDU, then it includes a bandwidth signaling TA and the signaled PPDU bandwidth is 20 MHz, 40 MHz, 80 MHz, or 160 MHz and identification of the channel occupied by a received CTS frame in a non-HT (duplicate) PPDU is determined by examining the RTS frame or the MU-RTS frame that elicited the CTS response).

In other words, for some NPCA designs, the conditions used for determining whether a STA may switch to an NPCA primary channel depend upon the classification of received PPDUs as inter-BSS PPDUs (e.g., rather than intra-PPDUs). Condition for intra-BSS PPDUs and inter-BSS PPDUs may be defined by one or more IEEE 802.11 standards. For example, in accordance with some such standards, a STA may classify a received PPDU as an inter-BSS PPDU if at least one of the following conditions is true: (a) the BSS color is not disabled and the RXVECTOR parameter BSS_COLOR is not 0 and is not the BSS color of the BSS of which the STA is a member; (b) the PPDU is a very high throughput (VHT) PPDU with RXVECTOR parameter PARTIAL_AID not equal to the BSSID of the BSS in which the STA is associated or another BSS (e.g., any of the other BSSs) in the same multiple BSSID set or co-hosted BSSID set to which its BSS belongs and the RXVECTOR parameter GROUP_ID is 0; (c) the PPDU is a VHT PPDU with RXVECTOR parameter PARTIAL_AID not equal to the 4 least significant bits (LSBs) of the BSS color announced by the BSS of which the STA whose dotl1ParticalBSSColorImplemented parameter is equal to true is a member and RXVECTOR parameter GROUP_ID equal to 63 when the partial BSS color field in the most recent high efficiency (HE) operation element is 1; (d) the PPDU is either a VHT MU PPDU or an HE MU PPDU with the RXVECTOR parameter UPLINK_FLAG equal to 0, and the STA is an AP; (e) the PPDU carries a frame that has a BSSID field, the value of which is not the BSSID of the BSS in which the STA is associated or another BSS (e.g., any of the other BSSs) in the same multiple BSSID set or co-hosted BSSID set to which its BSS belongs or the wildcard BSSID; (f) the PPDU carries a frame that does not have a BSSID field but has both a receiver address (RA) field and transmitter address (TA) field, neither value of which is equal to the BSSID of the BSS in which the STA is associated or another BSS (e.g., any of the other BSSs) in the same multiple BSSID set or co-hosted BSSID set to which its BSS belongs (the individual/group bit in the TA field is forced to 0 prior to comparison).

In such NPCA designs, however, the set of conditions defined for NPCA channel switching may be problematic for a BSS in which the AP has enabled NPCA and in which the AP is using a MAPC scheme (e.g., any of the MAPC schemes). For example, as described above, reception of an inter-BSS PPDU on the primary channel may trigger the AP and/or the non-AP STAs of such a BSS to switch to the NPCA primary channel. In other words, reception of an inter-BSS PPDU on the primary channel triggers both the AP and the non-AP STAs of such a BSS to consider switching to the NPCA primary channel. In some cases, however, such a switch may lead to inefficient use of resources. For example, the inter-PPDU may be from another BSS with which the AP has agreed to use one or more MAPC schemes. In such an example, the AP and/or the non-AP STAs may use a shared TXOP in accordance with the one or more MAPC schemes rather than switching to the NPCA primary channel. That is, if a sharing AP offers a shared AP an opportunity to use its TXOP with one of the MAPC schemes, the shared AP and the associated non-AP STAs in the BSS of the AP may (e.g., should) at least consider the offer instead of switching to the NPCA primary channel. Thus, for NPCA designs in which the conditions defined for NPCA channel switching rely on inter-BSS PPDUs, simultaneous use of NPCA and one or more MAPC may be inefficient. In other words, NPCA design rules in which all inter-BSS PPDUs are equal may cause the use of MAPC schemes with an NPCA enabled BSS to be inefficient (and thus undesirable for wireless communication networks).

Various aspects of the present disclosure provide a framework for simultaneous use of NPCA and MAPC schemes. For example, the framework may provide a means for one or more STAs (e.g., an NPCA capable AP STA and/or an NPCA capable non-AP STA) which belongs to an NPCA enabled BSS to determine whether a received PPDU is from a different BSS with which the NPCA enabled BSS has no MAPC agreement in place and/or whether a received PPDU is from a different BSS with which the NPCA enabled BSS has a MAPC agreement in place and/or with which a MAPC scheme is currently in use (e.g., with which the AP of the NPCA enabled BSS uses one or more of the MAPC schemes). In some examples in which a STA determines that a received PPDU is from a different BSS with which the NPCA enabled BSS has no MAPC agreement in place, the default behavior of the STA, in accordance with one or more aspects of the present disclosure, may include the STA using NPCA (if NPCA is enabled). In some examples in which a STA determines that a received PPDU is from a different BSS with which the NPCA enabled BSS has a MAPC agreement in place and/or with which a MAPC scheme is currently in use, the default behavior of the STA, in accordance with one or more aspects of the present disclosure, may include the STA not using NPCA. That is, the STA may refrain from using NPCA and, instead, determine to stay on the primary channel and make use of the coordination (e.g., the MAPC scheme). Various aspects of the present disclosure provide for modified signaling of a BSS color and/or APID that may be used to distinguish PPDUs from coordinated transmissions (e.g., intra-BSS PPDUs) vs. uncoordinated transmissions (e.g., inter-BSS PPDUs). Furthermore, various aspects of the present disclosure provide a framework for how the modified signaling may be implemented in accordance with one or more frame structures used for the various coordinating procedures, such as a Co-TDMA procedure, a Co-BF procedure, and a Co-SR procedure.

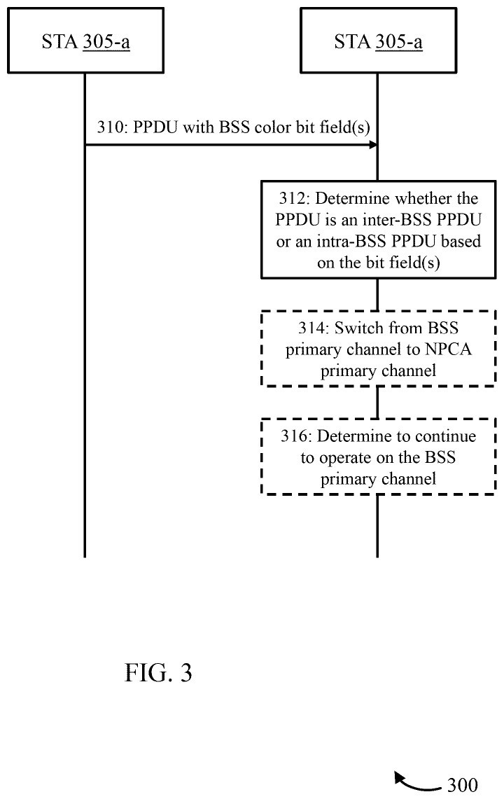

FIG. 3 illustrates an example signaling diagram 300 to which one or more examples disclosed herein may be applied. The signaling diagram 300 illustrates operations performed, such as within the system of FIG. 1 or 2A, by a STA 305-a and a STA 305-b in accordance with one or more aspects of the present disclosure. The STAs 305 may be examples of an AP or a non-AP STA illustrated by and described with reference to FIGS. 1, 2A, 2B, 2C, 2D, and 2E. For example, one or both of the STAs 305 may be capable of performing one or more NPCA operations. One or more operations performed at the STAs 305 may be performed in a different order than the example order shown. Additionally, or alternatively, one or more operations performed at the STAs 305 may be omitted and/or one or more other operations may be added. The signaling diagram 300 may support a framework for a common MAPC BSS color that enables simultaneous use of NPCA and MAPC schemes within a communication system.

For example, a wireless communications system may support BSS coloring, which assigns a unique label to each BSS, called the BSS color. In some examples, an AP randomly selects a color from color 1 to color 63 and indicates the selected color in a high efficiency (HE) operation element in a beacon, a probe response, and/or an association response. Each STA that is associated with that AP adopts that BSS color. For a frame sent in a BSS of an AP (e.g., any frame sent in the BSS), the transmitter of the frame indicates, in a signal (SIG) field of a PHY header, the BSS color associated with that BSS. The SIG field may be a high efficiency signal (HE-SIG) or universal signal (U-SIG) field, among other options. Thus, in such examples, a STA transmitting a frame may indicate the BSS color of the BSS to which the STA belongs. In such examples, however, the BSS color does not indicate whether a MAPC scheme is currently in use by the BSS. For example, the STA (e.g., an AP) may not share the TXOP over which the frame is sent (e.g., in accordance with Co-TDMA) or the frame may not be a coordinated transmission. Hence, a receiver of the frame (e.g., an AP or non-AP STA) may not know if the transmission of the frame (e.g., a current OBSS transmission) made use of a coordination scheme. In other words, a receiver of the frame (may not know if the frame was transmitted in accordance with a MAPC scheme. That is, in some examples, a STA may be unable to determine whether to treat a PPDU as an intra-BSS PPDU or an inter-BSS PPDU based on a BSS color. Hence, in such examples, BSS color may not be sufficient as an indication of a coordinated or uncoordinated transmission.

In some other examples, in accordance with one or more aspects of the present disclosure, one or more bit fields pertaining to BSS color may be used to indicate whether a PPDU is a coordinated or uncoordinated transmission (e.g., was transmitted in accordance with a MAPC scheme or outside of a MAPC scheme). In other words, one or more bit fields pertaining to BSS color may be used to indicate whether a PPDU is (or is to be treated as) an intra-BSS PPDU or an inter-BSS PPDU.

For example, for ultra-high reliability (UHR) devices, a group of BSS colors (where a group may be formed by a single BSS color or multiple BSS colors) may be allocated to one or more BSSs for use by the BSS(s) when the BSS(s) use one or more coordinating schemes, such as C-TDMA, C-SR and C-BF. The group of BSS colors may be selected from among a first set of 64 available colors. A BSS color from this group of BSS colors may be associated to multiple BSSs when these BSSs coordinate with each other and operate a coordinated scheme, such as C-TDMA, C-SR or C-BF. That is, when these BSSs operate in a coordinated manner (e.g., in accordance with a MAPC scheme), a BSS color from the group of BSS colors is indicated so that STAs belonging to those BSSs are aware that transmissions from that BSS color should not be treated as an OBSS. However, when these coordinating BSSs operate in an individual manner (e.g., outside of MAPC) the BSSs may indicate another (individual) BSS color. For example, for a coordinated transmission of a PPDU, a BSS color from the group of BSS colors is indicated in the PPDU so that STAs belonging to those BSSs may determine to treat the PPDU as an intra-BSS PPDU (rather than an inter-BSS PPDU). For an uncoordinated transmission of a PPDU from a BSS, another BSS color, which is individual to the BSS, is indicated in the PPDU so that STAs outside of the BSS may determine to treat the PPDU as an inter-BSS PPDU. In some examples of the framework, such as for Co-TDMA, one or more bit fields may be used to indicate one or more BSS colors associated with a BSS. It will be appreciated that the example bit fields described herein are merely examples and should not be construed to narrow the scope of the disclosure in any way. For example, the types of bit fields used may change based on coordinating scheme.

As illustrated in the example of FIG. 3, at 310, the STA 305-b may receive a PPDU including at least one bit field pertaining to at least one BSS color associated with the PPDU (e.g., a BSS color of a BSS from which the PPDU is transmitted). The PPDU may be an example of a UHR multi-user (MU) PPDU in U-SIG, a UHR trigger-based (TB) PPDU in U-SIG, or a UHR enhanced long range (ELR) PPDU in U-SIG. Example formats for UHR MU PPDU in U-SIG, UHR TB PPDU in U-SIG, and UHR ELR PPDU in U-SIG are illustrated in the following Tables 1, 2, and 3, respectively.

TABLE 1
(UHR MU PPDU)

| Two parts | | | Number | |
|---|---|---|---|---|
| of U-SIG | Bit | Field | of Bits | Description |
| | B7-B12 | BSS Color | 6 | An identifier of the BSS. |
| | | | | Set to the TXVECTOR parameter |
| | | | | BSS_COLOR. |
| | | | | If the UL/DL field is set to 0, the PPDU |
| | | | | Type And Compression Mode Field is set |
| | | | | to 1 and the Co-BF/Co-SR indication Field |
| | | | | is set to 0, is an identifier of the first |
| | | | | coordinated BSS in a DL SU Co-SR |
| | | | | transmission. |
| | | | | If the UL/DL field is set to 0, the PPDU |
| | | | | Type And Compression Mode Field is set |
| | | | | to 2 and the Co-BF/Co-SR Indication Field |
| | | | | is set to 0, is an identifier of the first |
| | | | | coordinated BSS in a DL non-OFDMA |
| | | | | Co-BF transmission. |
| | B13-B19 | TXOP | 7 | If the TXVECTOR parameter |
| | | | | TXOP_DURATION is UNSPECIFIED, |
| | | | | set to 127 to indicate the absence of |
| | | | | duration information. |
| | | | | If the TXVECTOR parameter |
| | | | | TXOP_DURATION is an integer value, |
| | | | | set to a value less than 127 to indicate |
| | | | | duration information for NAV setting and |
| | | | | protection of the TXOP as follows: |
| | | | | If the TXVECTOR parameter |
| | | | | TXOP_DURATION is less than 512, set to |
| | | | | 2 × └TXOP_DURATION/8┘. |
| | | | | Otherwise, set to |
| | | | | 2 × └(TXOP_{DURATION} − 512)/128┘ + 1 |
| | B20-B25 | BSS Color 2 | 6 | If the UL/DL field is set to 0, the PPDU |
| | | | | Type And Compression Mode Field is set |
| | | | | to 1 and the Co-BF/Co-SR indication Field |
| | | | | is set to 0, is an identifier of the second |
| | | | | coordinated BSS in a DL SU Co-SR |
| | | | | transmission. Set to the TXVECTOR |
| | | | | parameter BSS_COLOR_2. |
| | | | | If the UL/DL field is set to 0, the PPDU |
| | | | | Type And Compression Mode Field is set |
| | | | | to 2 and the Co-BF/Co-SR Indication Field |
| | | | | is set to 0, is an identifier of the second |
| | | | | coordinated BSS in a DL non-OFDMA |
| | | | | Co-BF transmission. Set to the |
| | | | | TXVECTOR parameter BSS_COLOR_2. |
| | | | | Otherwise, B20-B25 are set to all 1s and |
| | | | | treat as Disregard. B25 is set to 1 and treat |
| | | | | as Validate. |

TABLE 2
(UHR TB PPDU)

| Two parts | | | Number | |
|---|---|---|---|---|
| of U-SIG | Bit | Field | of Bits | Description |
| U-SIG-1 | B0-B2 | PPHY | 3 | Differentiate between different PHY |
| | | Version | | clauses. |
| | | Identifier | | Set to 1 for UHR |
| | | | | Values 2-7 are Validate |
| | | | | NOTE-Set to 0 for EHT |
| | B3-B5 | Bandwidth | 3 | Set to 0 for 20 MHz |
| | | | | Set to 1 for 40 MHz |
| | | | | Set to 2 for 80 MHz |
| | | | | Set to 3 for 160 MHz |
| | | | | Set to 4 for 320 MHz-1 |
| | | | | Set to 5 for 320 MHz-2 |
| | | | | Values 6 and 7 are Validate. |
| | B6 | UL/DL | 1 | Set to 1 to indicate that the PPDU is |
| | | | | addressed to the AP. |
| | B7-B12 | BSS Color | 6 | An identifier of the BSS. |
| | | | | Set to the TXVECTOR parameter |
| | | | | BSS_COLOR. |
| | B13-B19 | TXOP | 7 | If the TXVECTOR parameter |
| | | | | TXOP_DURATION is UNSPECIFIED, |
| | | | | set to 127 to indicate the absence of |
| | | | | duration information. |
| | | | | If the TXVECTOR parameter |
| | | | | TXOP_DURATION is an integer value, |
| | | | | set to a value less than 127 to indicate |
| | | | | duration information for NAV setting and |
| | | | | protection of the TXOP as follows: |
| | | | | If the TXVECTOR parameter |
| | | | | TXOP_DURATION is less than 512, set to |
| | | | | 2 × └TXOP_DURATION/8┘. |
| | | | | Otherwise, set to |
| | | | | 2 × └(TXOP_{DURATION} − 512)/128┘ + 1 |
| | B20-B25 | BSS Color 2 | 6 | Set to the value of the TXVECTOR |
| | | | | parameter TB_DISREGARD_IN_USIG1 |
| | | | | and treat as Disregard. |

TABLE 3
(UHR ELR PPDU)

| Two parts | | | Number | |
|---|---|---|---|---|
| of U-SIG | Bit | Field | of Bits | Description |
| U-SIG-1 | B0-B2 | PPHY | 3 | Differentiate between different PHY |
| | | Version | | clauses. |
| | | Identifier | | Set to 1 for UHR |
| | | | | Values 2-7 are Validate |
| | | | | NOTE-Set to 0 for EHT |
| | B3-B5 | Bandwidth | 3 | Set to 0 for 20 MHz |
| | | | | Values 1-7 are Validate. |
| | B6 | UL/DL | 1 | Indicates whether the PPDU is sent in UL |
| | | | | or DL. Set to the TXVECTOR parameter |
| | | | | UPLINK_FLAG. |
| | | | | A value of 1 indicates the PPDU is |
| | | | | addressed to an AP. |
| | | | | A value of 0 indicates the PPDU is |
| | | | | addressed to a non-AP STA. |
| | | | | NOTE-In 5 GHz band or 6 GHz band, the |
| | | | | value is always set to 1. |
| | B7-B12 | BSS Color | 6 | An identifier of the BSS. |
| | | | | Set to the TXVECTOR parameter |
| | | | | BSS_COLOR. |

The “BSS color” bit field and/or the “BSS color 2” bit field, as shown in Tables 1 through 3, may be modified (or reinterpreted) in accordance with various aspects of the present disclosure to indicate whether a PPDU carrying the “BSS color” bit field and/or the “BSS color 2” is from (1) a different BSS with which the NPCA enabled BSS has no MAPC agreement in place or (2) a different BSS with which the NPCA enabled BSS has a MAPC agreement in place and/or with which a MAPC scheme is currently in use (e.g., a different BSS with which the AP of the NPCA enabled BSS uses one or more of the MAPC schemes). In other words, the “BSS color” bit field and/or the “BSS color 2” bit field, as shown in Tables 1 through 3, may be modified (or reinterpreted) in accordance with various aspects of the present disclosure to indicate whether a PPDU carrying the “BSS color” field and/or the “BSS color 2” field is to be treated as an inter-BSS PPDU or an intra-BSS PPDU.

For example, for a UHR MU PPDU in U-SIG, as illustrated in Table 1, the PPDU may include the “BSS color” bit field and the “BSS Color 2” bit field. In some examples, in accordance with various aspects of the present disclosure, the “BSS color” bit field may indicate a BSS color used when the STA 305-a operates individually and the “BSS color 2” bit field may indicate another BSS color to use when the STA 305-a-operates in accordance with a MAPC scheme. In other words, the “BSS color” bit field may indicate a BSS color associated with uncoordinated transmissions by the STA 305-a and the “BSS Color 2” bit field may indicate-a BSS color (e.g., a different BSS color) associated with coordinated transmissions.

For a UHR TB PPDU in U-SIG, as illustrated in Table 2, the PPDU may include a “BSS color” field, which is used to indicate the BSS color used when the STA operates individually. In some examples, in accordance with various aspects of the present disclosure, another field may be introduced (e.g., in addition to the “BSS color” field), which is used to indicate the BSS color to use when the STA 305-a is operating in accordance with a MPAC scheme. The other field may be a “BSS color 2” field or another type of field.

For a UHR ELR PPDU in U-SIG, as illustrated in Table 3, the PPDU may include a “BSS color” field, which is used to indicate the BSS color used when the STA operates individually. In some examples, in accordance with various aspects of the present disclosure, another field may be introduced (e.g., in addition to the “BSS color” field), which is used to indicate the BSS color to use when the STA 305-a is operating in accordance with a MPAC scheme. The other field may be a “BSS color 2” field or another type of field.

In some other examples, information included in the BSS color field (or another type of field) may be modified by enhancing the bit length of the BSS color field with one or more additional bits so that, on top of the first set of 64 BSS colors, a second set of BSS colors may be defined. The second set of BSS colors may be used (and allocated) when coordinating schemes, such as Co-TDMA, Co-SR and Co-BF, are used. A BSS color from the second set of BSS colors may be associated to multiple BSSs when these BSSs coordinate with each other and operate a coordinated scheme, such as Co-TDMA, Co-SR or Co-BF. When these coordinating BSSs operate in an individual manner, the BSSs may indicate a BSS color from the first set of BSS colors (e.g., their individual BSS color). However, when these BSSs operate a coordinated scheme, the BSSs may indicate a BSS color from the second set of BSS colors so that STAs belonging to those BSSs are aware that transmissions from that BSS color should not be treated as an OBSS. For example, a BSS color from the second set of BSS colors may be indicated in a PPDU so that STAs belonging to those BSSs may determine to treat the PPDU as an intra-BSS PPDU (rather than an inter-BSS PPDU).

Additionally, or alternatively, one or more additional bits may be added on top of the BSS color field information to indicate when one or more coordination schemes, such as C-TDMA, C-SR and C-BF, are used. Such bits may be referred to as “Coordination in Use bit(s)”. When the BSSs operate in accordance with the MAPC scheme, the MAPC scheme may be indicated by the Coordination in Use bit(s). That is, when a BSS of multiple BSSs operating in accordance with a MAPC scheme performs a transmission, the transmission may include the Coordination in Use bit(s) to indicate the MAPC scheme, so that STAs of coordinated BSS are aware that the transmission should not be treated as an OBSS. For example, a MAPC scheme may be indicated in a PPDU so that STAs belonging to the coordinated BSSs may determine to treat the PPDU as an intra-BSS PPDU (rather than an inter-BSS PPDU).

The STAs 305 may support one or more options for the Coordination in Use bit(s). For example, the Coordination in Use bit(s) may be a single bit that indicates that coordination is used for the (current) transmission. In other words, the Coordination in Use bit(s) may be a single bit in a PPDU, which indicates that the transmission of the PPDU was in accordance with MAPC. In some other examples, the Coordination in Use bit(s) may be a number of bits (e.g., 3 bits) that indicate a type of MAPC scheme currently in place (Co-TDMA, Co-BF, Co-SR). In other words, the Coordination in Use bit(s) may be multiple bits in a PPDU, which indicate a type of MAPC scheme associate with the transmission of the PPDU. In some other examples, the Coordination in Use bit(s) may be a number of bits (e.g., 3) that indicate which BSS(s) are part of the coordinated transmission. That is, the Coordination in Use bit(s) may be multiple bits in a PPDU, which indicate one or more BSSs associated with the transmission of the PPDU in accordance with an MAPC. For example, an AP may have a Co-BF agreement with multiple other APs (BSS1, BSS2, BSS3) but this Co-BF transmission may be (only) for BSS1. In such an example, the Coordination in Use bits may indicate BSS1. In some other examples, the Coordination in Use bit(s) may be a number of bits that indicate a group of BSSs among which one or more coordination schemes are in place, and whose transmissions should not be considered as an OBSS. In other words, the Coordination in Use bit(s) may be multiple bits in a PPDU, which indicate a group of BSSs associated with one or more MAPC schemes.

In some examples, the BSS color indicated by a STA may be a BSS color that is negotiated among the coordinating APs and is be used in these BSSs when the coordination is in place. In some other examples, the BSS color indicated by a STA may be the BSS color when the BSS operates individually. The Coordination in Use bit(s) may be used to indicate that the BSS color is the BSS color used for coordination and/or when the BSS operates individually.

For example, for the UHR MU PPDU, the “BSS color” and/or “BSS Color 2” fields in U-SIG, as illustrated in Table 1, may be extended from 6 bits to 7 bits. In such an example, one or more of the 7 bits (e.g., the extra bit(s)) may be used to define either another BSS colors for coordination or the Coordination in Use bit(s), where the extra bit(s) may be retrieved by reinterpreting one or more other fields (e.g., validate bits). As another example, the “BSS color” and “BSS Color 2” fields in U-SIG, as illustrated in Table 1, may be used to indicate the BSS color used when the BSS operates individually and the BSS color to use when operating a coordination scheme, respectively.

In some examples, for the UHR TB PPDU, the “BSS color” field in U-SIG, as illustrated in Table 2, may be extended from 6 bits to 7 bits. In such examples, one or more of the 7 bits (e.g., the extra bit(s)) may be used to define either a (new) BSS colors for coordination or the Coordination in Use bit(s). The extra bit(s) may be retrieved by reinterpreting one or more other fields (e.g., validate bits). As another example, another field may be introduced (e.g., the “BSS color 2” field or another type of field) to indicate the BSS color to use when operating a coordination scheme, while the “BSS color” field may continue to be used to indicate the BSS color when the BSS operates individually.

In some examples, for the UHR ELR PPDU, the “BSS color” field in U-SIG, as illustrated in Table 3, may be extended from 6 bits to 7 bits. In such examples, one or more of the 7 bits (e.g., the extra bit(s)) may be used to define either a (new) BSS colors for coordination or the Coordination in Use bit(s). The extra bit(s) may be retrieved by reinterpreting on or more other fields (e.g., validate bits). As another example, another field may be introduced (e.g., the “BSS color 2” field or another type of field) to indicate the BSS color to use when operating a coordination scheme, while the “BSS color” field may continue to be used to indicate the BSS color when the BSS operates individually. Although the examples described herein are described in the context of the U-SIG, the examples provided herein may also apply to other types of signals, such as the UHR-SIG.

In some examples, a single AP may have multiple coordination groups with other APs (e.g., multiple pairwise agreements) and each of these coordination groups may be assigned a respective (e.g., separate) BSS color. As used herein, a coordination group refers to a set of at least two APs (e.g., a sharing AP and at least one shared AP) that have a MAPC agreement in place. Accordingly, in such examples, the single AP may be associated with multiple BSS colors for operating multiple coordination schemes.

At 312, the STA 305-b may determine whether the PPDU is an inter-BSS PPDU or an intra-BSS PPDU based on the bit field(s). For example, the STA 305-b may determine that the PPDU is the inter-BSS PPDU based on the bit field including at least one bit that is indicative of a first BSS color associated with a single BSS operating outside of a MAPC scheme. In other words, the STA 305-b may determine that the PPDU is the inter-BSS PPDU based on the bit field indicating a BSS color individual to the BSS from which the PPDU originated. Alternatively, the STA 305-b may determine that the PPDU is the intra-BSS PPDU based on the bit field including at least one bit that is indicative of a second BSS color associated with multiple BSSs operating in accordance with an MAPC scheme. In other words, the STA 305-b may determine that the PPDU is the intra-BSS PPDU based on the bit field indicating a BSS color that is common to multiple BSSs operating in accordance with an MAPC scheme.

In some other examples, the STA 305-b may determine that the PPDU is the inter-BSS PPDU based on the bit field being a first bit field (e.g., the “BSS color” field) associated with BSS operations outside of a MAPC scheme. Alternatively, the STA 305-b may determine that the PPDU is the intra-BSS PPDU based on the bit field being a second bit field (e.g., the “BSS color 2” field) associated with BSS operations in accordance with an MAPC scheme.

In yet some other examples, the STA 305-b may determine that the PPDU is the inter-BSS PPDU based on the BSS color being one of a first set of BSS colors associated with BSS operations outside of a MAPC scheme. In other words, the STA 305-b may determine that the PPDU is the inter-BSS PPDU based on the BSS color being one of a first set of 64 BSS colors (or another suitable quantity of colors) associated with individual (uncoordinated) transmissions. Alternatively, the STA 305-b may determine that the PPDU is the intra-BSS PPDU based on the BSS color being one of a second set of BSS colors associated with BSS operations in accordance with an MAPC scheme. In other words, the STA 305-b may determine that the PPDU is the intra-BSS PPDU based on the BSS color being one of a second set of BSS colors associated with coordinated transmissions.

In some examples, the STA 305-b may determine that the PPDU is the intra-BSS PPDU based on the bit field including at least one bit (e.g., Coordination in Use bit(s)) indicating that the PPDU is associated with MAPC. In some other examples, the STA 305-a may determine that the PPDU is the intra-BSS PPDU based on the bit field including at least one bit indicating a BSS color corresponding to a MAPC group of multiple MAPC groups associated with a BSS of the STA. For example, the BSS of the STA may be associated with multiple MAPC groups, in which each MAPC group includes the BSS and at least one other BSS having at least one MAPC agreement with the BSS. In such an example, the multiple MAPC groups may be associated with multiple BSS colors (e.g., each MAPC group is associated with a respective BSS color).

In some examples, irrespective of how the BSS color used with a coordinating scheme is formed and/or how the indication of the coordination is performed, a STA uses the BSS color information to determine whether NPCA switching may occur if a PPDU overlaps with the BSS primary channel (e.g., based upon one or more conditions). In some examples, if the BSS color of the PPDU overlapping with the BSS primary channel does not indicate that the transmission is from (1) the BSS to which the STA is associated, or (2) a coordination group of the BSS to which the STA is associated, then a STA may trigger switching to NPCA primary channel (e.g., if NPCA is enabled and one or more switching conditions are met, such as conditions 1) or 2) described in Section 37.10 of 802.11bn). Alternatively, if the BSS color of the PPDU overlapping with the primary channel is equal to (one of) the BSS colors belonging to (1) the BSS to which the STA is associated, or (2) a coordination group of the BSS to which the STA is associated, then a STA may not trigger switching to NPCA primary channel within a shared TXOP. In other words, if the PPDU overlapping with the BSS primary channel indicates a BSS color of a different BSS with which the BSS of the STA has no MAPC agreement in place, then the STA may treat the PPDU as an inter-BSS PPDU and switch to the NPCA primary channel. Alternatively, if the PPDU overlapping with the BSS primary channel indicates a BSS color of the BSS including the STA, a different BSS with which the BSS of the STA has a MAPC agreement in place, or a different BSS with which a MAPC scheme is currently in use, then the STA may treat the PPDU as an intra-BSS PPDU and continue to operate on the BSS primary channel.

In some examples, at 314, the STA 305-b may switch from the BSS primary channel (e.g., a primary channel associated with the BSS of the STA 305-b) to the NPCA primary channel (e.g., another channel associated with NPCA). For example, the STA 305-b may determine that the PPDU is the inter-BSS PPDU based on the bit field(s) and, in response to the determination, switch from the BSS primary channel (used to receive the PPDU) to the NPCA primary channel.

Alternatively, at 316, the STA 305-b may determine that the PPDU is the intra-BSS PPDU based on the bit field. In such an example, the STA 305-b may determine to continue to operate on the BSS primary channel (e.g., may not treat the PPDU as an OBSS transmission). In some examples, by enabling BSSs to use a common BSS color for coordinated transmissions, the BSSs may improve resource utilization and reduce latency within a communications system.

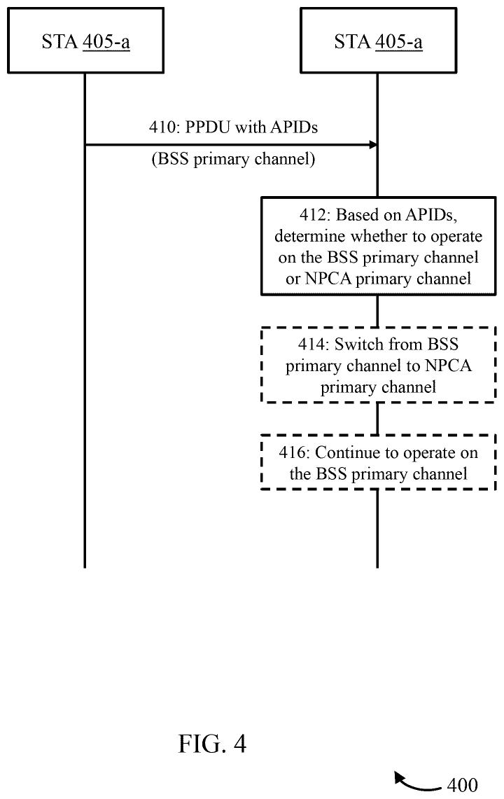

FIG. 4 illustrates an example signaling diagram 400 to which one or more examples disclosed herein may be applied. The signaling diagram 400 illustrates operations performed, such as within the system of FIG. 1 or 2A, by a STA 405-a and a STA 405-b in accordance with one or more aspects of the present disclosure. The STAs 405 may be examples of an AP or a non-AP STA illustrated by and described with reference to FIGS. 1, 2A, 2B, 2C, 2D, and 2E. For example, one or both of the STAs 405 may be capable of performing one or more NPCA operations. One or more operations performed at the STAs 405 may be performed in a different order than the example order shown. Additionally, or alternatively, one or more operations performed at the STAs 405 may be omitted and/or one or more other operations may be added. The signaling diagram 400 may support a framework for indication of APIDs for MAPC that enables simultaneous use of NPCA and MAPC schemes within a communication system.

At 410, the STA 405-b may receive, via a BSS primary channel (e.g., a first primary channel of a BSS associated with the STA), a PPDU including APID information that indicates multiple APIDs of multiple APs operating in accordance with at least one MAPC scheme. In other words, an APID indication of the shared and sharing AP(s) is included in the PPDU when a coordination scheme (e.g., a MAPC scheme) is used. In some examples, an APID indication of the shared and sharing AP(s) is included in the U-SIG and/or UHR-SIG information of a UHR MU PPDU, a UHR TB PPDU and/or a UHR ELR PPDU when a coordination scheme is used.

At 412, based on the APIDs, the STA 405-b may determine whether to operate on the BSS primary channel or the NPCA primary channel. For example, the STA 405-b may use the APID information provided in the PPDU to determine whether NPCA switching may occur if the PPDU overlaps with the BSS primary channel based upon one or more conditions.

In some examples, at 414, the STA 405-b may determine to operate on the NPCA primary channel based on the indicated APIDs being different from an APID of an AP associated with the STA 405-b. For example, if (all) the APIDs indicated in the U-SIG and/or UHR-SIG are individually different than the APID of an AP associated with the STA 405-b (e.g., an AP serving the STA 405-b, or an AP otherwise associated with the STA 405-b), then the STA 405-b may trigger switching to the NPCA primary channel (e.g., if NPCA is enabled and one or more switching conditions are met, such as conditions 1) or 2) described in Section 37.10 of 802.11bn). In such examples, the STA 405-b may switch from the BSS primary channel to the NPCA primary channel.

Alternatively, at 416, the STA 405-b may determine to operate on the BSS primary channel based on at least one APID of the indicated APIDs being equal to an APID of the AP associated with the STA 405-b. For example, if at least one of the APIDs indicated in the U-SIG and/or UHR-SIG is equal to the APID of the associated AP, then the STA 405-b may not trigger switching to NPCA primary channel within a shared TXOP. In such examples, the STA 405-b may continue to operate on the BSS primary channel.

In some examples, the STA 405-b may use the APID information to determine one or more other coordinating APs with which the AP associated to the STA is operating a coordinated procedure. Additionally, or alternatively, the STA 405-b may use the APID information to determine whether NPCA switching may occur if a PPDU overlaps with the primary channel.

For example, the STA 405-b may monitor for one or more ICRs from an AP associated with the STA (e.g., the STA 405-a). In such an example, the STA 405-b may determine whether to operate on the BSS primary channel or the NPCA primary channel based on the monitoring. In some examples, if (all) the APIDs indicated in the U-SIG and/or UHR-SIG are different from the APID belonging to the associated AP, then the STA 405-b may trigger switching to the NPCA primary channel (e.g., if NPCA is enabled and one or more switching conditions are met, such as conditions 1) or 2) described in Section 37.10 of 802.11bn). That is, the STA 405-b may determine to operate on the NPCA primary channel based on the indicated APIDs being different from an APID of the AP associated with the STA. Alternatively, if at least one of the APIDs indicated in the U-SIG and/or UHR-SIG of the PPDU overlapping with the BSS primary channel is equal to the APID belonging to the associated AP, then the STA 405-b may not trigger switching to NPCA primary channel within a shared TXOP. In some examples, the STA may trigger switching to the NPCA primary channel outside of the shared TXOP.

Differentiation between switching and not switching to the NPCA primary channel may be, for instance, inferred by the STA 405-b by monitoring for an ICR from the associated AP. For example, if an ICR is received, then NPCA triggering may not be allowed, otherwise NPCA triggering may be allowed.

In some examples, the STA 405-b may receive, via the first primary channel, an ICR associated with a transmission opportunity shared between the AP and at least one other AP in accordance with the at least one MAPC scheme. In such an example, the STA 405-b may determine to continue to operate on the BSS primary channel within the share TXOP based on the reception of the ICR and at least one APID of the indicated APIDs being equal to an APID of the AP. In some other examples, the STA 405-b may determine to operate on the NPCA primary channel outside of the shared TXOP based on a failure to detect an ICR associated with the shared TXOP and at least one APID of the indicated APIDs being equal to the APID of the AP. In some examples, an AP (e.g., the AP associated with the STA 405-b) may be assigned multiple APIDs. For example, the AP may be assigned a respective APID for each of multiple coordinated groups. In some such examples, the APID of the AP associated to the STA may be one of multiple APIDs associated with the AP, in which each of the multiple APIDs is associated with a respective MAPC agreement between the AP and at least one other AP. For example, the APID of the associated AP may be different for different sharing APs since APIDs may be set individually for each AP pair. In some examples, by enabling BSSs to indicate APIDs of coordinating APs, the BSSs may improve resource utilization and reduce latency within a communications system.

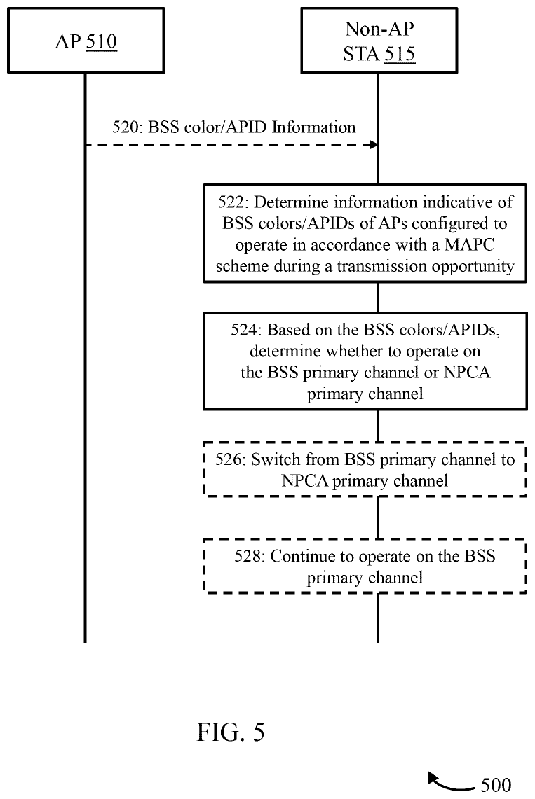

FIG. 5 illustrates an example signaling diagram 500 to which one or more examples disclosed herein may be applied. The signaling diagram 500 illustrates operations performed, such as within the system of FIGS. 1 and 2A, by an AP 510 and a non-AP STA 515 in accordance with one or more aspects of the present disclosure. The AP 510 and the non-AP STA 515 may be examples of the corresponding devices illustrated by and described with reference to FIGS. 1, 2A, 2B, 2C, 2D, and 2E. For example, the AP 510 and/or the non-AP STA 515 may be capable of performing one or more NPCA operations. One or more operations performed at the AP 510 and the non-AP STA 515 may be performed in a different order than the example order shown. Additionally, or alternatively, one or more operations performed at the AP 510 and the non-AP STA 515 may be omitted and/or one or more other operations may be added. The signaling diagram 500 may support a framework for MAPC that enables simultaneous use of NPCA and MAPC schemes within a wireless communications system.

At 522, the non-AP STA 515 determines information that indicates multiple identifiers associated with multiple APs configured to operate in accordance with a MAPC scheme during a transmission opportunity (TXOP), where the multiple identifiers include multiple BSS colors and/or multiple APIDs. In other words, the non-AP STA 515 may determine information indicative of BSS colors/APIDs of APs configured to operate in accordance with a MAPC scheme during a TXOP (e.g., a shared TXOP).

At 524, based on the identifiers, the non-AP STA 515 may determine whether to operate on a BSS primary channel (e.g., the primary channel of the BSS of the non-AP STA 515) or an NPCA primary channel. In other words, based on the determined BSS colors/APIDs, the non-AP STA 515 may determine whether to operate on the BSS primary channel or the NPCA primary channel.

In some examples, the APs may be configured to operate in accordance with a Co-TDMA procedure, a Co-BF procedure, or a Co-SR procedure. In some such examples, the BSS colors/APIDs of the coordinating APs may be indicated to the non-AP STA 515 via a beacon frame, management/control frame, action frame, or data frame. For example, a (new) BSS color information field may be carried in a beacon frame, management/control frame, action frame, or data frame, which carries the BSS color of the shared AP(s) and/or the BSS color of the sharing AP participating in Co-TDMA, Co-BF, or Co-SR. In such an example, the BSS color information field may be carried in a UHR operation element. Additionally, or alternatively, a (new) APID information field may be carried in a beacon frame, management/control frame, action frame, or data frame, which carries the APID(s) of the shared AP(s) and/or the APID of the sharing AP participating in Co-TDMA, Co-BF, or Co-SR. In such an example, the APID information field may be carried in a UHR operation element. In some other examples, an HE operating element indicating the BSS color may be reinterpreted so that the HE operating element indicates, to an UHR device, the BSS color of the shared AP(s) and/or the BSS color of sharing AP participating in Co-TDMA, Co-BF, or Co-SR. Additionally, or alternatively, an HE operating element indicating APID(s) may be reinterpreted so that the HE operating element indicates, to an UHR device, the APID(s) of the shared AP(s) and/or the APID of sharing AP participating in Co-TDMA, Co-BF, or Co-SR.

For example, at 520, the non-AP STA 515 may receive BSS color/APID information via a beacon frame, management/control frame, action frame, or data frame. The BSS color/APID information may be indicative of BSS colors/APIDs of the APs configured to operate in accordance with the MAPC scheme during the TXOP. That is, the BSS color/APID information may be indicative of a BSS color/APID of the sharing AP (e.g., the AP that obtained the TXOP) and one or more BSS colors/APIDs of one or more shared APs (e.g., the AP(s) with which the TXOP is shared).

As an illustrative example, the multiple identifiers may include multiple BSS colors. In such an example, the non-AP STA 515 may determine to operate on the BSS primary channel based on at least one BSS color of the multiple BSS colors being equal to a BSS color associated with the BSS of the non-AP STA 515. Alternatively, in such an example, the non-AP STA 515 may determine to operate on the NPCA primary channel based on at least one BSS color of the multiple BSS colors being different from the BSS color associated with the BSS of the non-AP STA 515.

In some examples, a U-SIG and/or UHR-SIG may carry first BSS information related to a BSS transmitting the corresponding PPDU, where the first information is indicative of a BSS color/APID related to the BSS transmitting the corresponding PPDU. Additionally, the U-SIG and/or UHR-SIG may also separately carry, in a different field, second BSS information of other BSSs participating (e.g., coordinating) with the BSS in a shared TXOP for a Co-TDMA procedure, a Co-BF procedure, or a Co-SR procedure, where the second BSS information is indicative of one or more BSS colors/APIDs of one or more other BSSs participating with the BSS in the shared TXOP.

In some examples, the non-AP STA 515 may receive a frame including a single bit field that is indicative of the first BSS information and/or the second BSS information. For example, the non-AP STA 515 may receive a single frame including a bit field that is indicative of the multiple identifiers associated with the multiple APs configured to operate in accordance with the MAPC scheme during the TXOP. In some other examples, the non-AP STA may receive a frame including multiple bit fields that are indicative of the first BSS information and the second BSS information. For example, the non-AP STA 515 may receive a frame including a first bit field and a second bit field, where the first bit field is indicative of a first identifier associated with transmission of a PPDU via the BSS primary channel, and where the second bit field is indicative of the multiple identifiers associated with the multiple APs configured to operate in accordance with the MAPC scheme during the TXOP. In some examples, such as examples in which BSS information indicates BSS color(s), the U-SIG and/or UHR-SIG may carry the first BSS information related to the BSS transmitting the PPDU as first BSS color information and the second BSS information of the other, participating BSSs as second BSS color information. Such information (and fields) may be applied to the MU PPDU, ELR PPDU and/or TB PPDU.

In some examples, the non-AP STA 515 may use BSS information (e.g., the second BSS information) to determine one or more BSS colors/APIDs of other, coordinating AP(s) with which the AP associated to the non-AP STA 515 is operating one or more coordinated procedures, such as a Co-TDMA procedure, a Co-BF procedure, a Co-SR procedure. Additionally, or alternatively, the non-AP STA 515 may determine, based on the one or more BSS colors/APIDs of the coordinating AP(s), whether NPCA switching may occur if a PPDU overlaps with the BSS primary channel of the BSS including the non-AP STA 515.

For example, the non-AP STA 515 may determine to operate on the NPCA primary channel based on at least one determined BSS color/APID being different from the BSS color/APID associated with the BSS/AP of the non-AP STA 515. In such an example, at 526, the non-AP STA 515 may switch from the BSS primary channel of the non-AP STA 515 to the NPCA primary channel.

Alternatively, the non-AP STA 515 may determine to operate on the BSS primary channel based on at least one determined BSS color/APID being equal to a BSS color/APID associated with the BSS/AP of the non-AP STA 515. The at least one BSS color/APID may correspond to the BSS color/APID of the BSS/AP of the non-AP STA 515, or the at least one BSS color/APID may correspond to a BSS color/APID of a BSS/AP participating in a coordinated procedure with the BSS/AP of the non-AP STA 515. In such an example, at 528, the non-AP STA 515 may continue to operate on the BSS primary channel.

In some other examples, the non-AP STA 515 may determine to operate on the BSS primary channel based on a first BSS color/APID of a PPDU (that overlaps with the BSS primary channel) being equal to (1) a BSS color/APID associated with the BSS, or (2) at least one BSS color/APID associated with the APs configured to operate in accordance with the MAPC scheme. Alternatively, the non-AP STA 515 may determine to operate on the NPCA primary channel based on the first BSS color/APID of the PPDU being different from (1) the BSS color/APID associated with the BSS, or (2) the at least one BSS color/APID associated with the APs configured to operate in accordance with the MAPC scheme.

In some examples, the APs may be operating in accordance with a Co-TDMA procedure. In some such examples, if the BSS color/APID of the PPDU overlapping with the BSS primary channel does not indicate that the PPDU is a transmission of (1) the BSS of the non-AP STA 515, or (2) a BSS in a coordination group associated with the BSS of the non-AP STA 515, then the non-AP STA 515 may trigger switching to the NPCA primary channel if NPCA is enabled (e.g., if the NPCA operation information present field corresponding to the BSS is equal to 1) and one or more switching conditions are satisfied (e.g., conditions 1) or 2) described in Section 37.10 of 802.11bn).

Alternatively, if the BSS color/APID of the PPDU overlapping with the BSS primary channel is equal to (one of) the BSS colors/APIDs belonging to (1) the BSS of the non-AP STA 515, or (2) a BSS in a coordination group associated with the BSS of the non-AP STA 515, then the non-AP STA 515 may not trigger switching to the NPCA primary channel within a shared TXOP. For example, NPCA may not be triggered at a STA (e.g., any STA) participating to a shared TXOP by a frame exchange (e.g., any frame exchange) occurring among other participating STAs within that TXOP. In such an example, the non-AP STA 515 may trigger switching to the NPCA primary channel outside of the shared TXOP. That is, NPCA may be triggered at an AP and one or more associated non-AP STAs when the AP is not currently operating as part of a shared TXOP. In some examples, differentiation between triggering and not triggering switching to the NPCA primary channel may be inferred by the non-AP STA 515 by monitoring for an ICR from the AP associated with the non-AP STA 515. For example, if an ICR is received by the non-AP STA 515, then NPCA triggering may not be allowed, otherwise NPCA triggering may be allowed.

In some other examples, the APs may be operating in accordance with a Co-BF procedure or a Co-SR procedure. In some such examples, if the BSS color/APID of a PPDU overlapping with the BSS primary channel does not indicate that the PPDU is a transmission of (1) the BSS of the non-AP STA 515, or (2) a BSS in a coordination group associated with the BSS of the non-AP STA 515, then the non-AP STA 515 may trigger switching to the NPCA primary channel if NPCA is enabled (e.g., if the NPCA operation information present field corresponding to the BSS is equal to 1) and one or more switching conditions are satisfied (e.g., conditions 1) or 2) described in Section 37.10 of 802.11bn).

Alternatively, if the BSS color/APID of the PPDU overlapping with the BSS primary channel is equal to (one of) the BSS colors/APIDs belonging to (1) the BSS of the non-AP STA 515, or (2) a BSS in a coordination group associated with the BSS of the non-AP STA 515, then the non-AP STA 515 may not trigger switching to the NPCA primary channel within a shared TXOP. For example, NPCA may not be triggered at an AP or non-AP STA (e.g., any AP or non-AP STAs) participating to the Co-BF/Co-SR procedure by either a frame exchange (e.g., any frame exchange) occurring among participating STAs or by a concurrent DL PPDU transmission (e.g., any concurrent DL PPDU transmission) within a shared TXOP. In such an example, the non-AP STA 515 may trigger switching to the NPCA primary channel outside of the shared TXOP. That is, NPCA may be triggered at an AP and one or more associated non-AP STAs when the AP is not currently operating as part of a shared TXOP.

In some examples, differentiation between triggering and not triggering switching to the NPCA primary channel may be inferred by the non-AP STA 515 by monitoring for a Co-BF/Co-SR invite, a Co-BF/Co-SR response, or an ICF from the AP associated with the non-AP STA 515. For example, if one of the aforementioned frames (e.g., any of the aforementioned frames) is received by the non-AP STA 515, then NPCA triggering may not be allowed, otherwise NPCA triggering may be allowed.

For example, the non-AP STA 515 may monitor for a message associated with a shared TXOP from an AP (e.g., the AP 510). The message may include a Co-BF request, a Co-BF response, a Co-SR request, a Co-SR response, an ICF, or an ICR. In such an example, determining whether to operate on the BSS primary channel or the NPCA primary channel (e.g., at 522) may be based on the monitoring. In some examples, the non-AP STA 515 may receive the message from the AP via the BSS primary channel. In such examples, the non-AP STA 515 may determine to continue to operate on the BSS primary channel within the shared TXOP based on the reception of the message and a BSS color/APID of a PPDU (which overlaps with the BBS primary channel) corresponding to (1) the BSS of the non-AP STA 515, or (2) a BSS in a coordination group associated with the BSS of the non-AP STA 515. In some other examples, the non-AP STA 515 may determine to operate on the NPCA primary channel outside of the shared TXOP based on a failure to detect the message from the AP and a BSS color/APID of a PPDU (which overlaps with the BBS primary channel) corresponding to (1) the BSS of the non-AP STA 515, or (2) a BSS in a coordination group associated with the BSS of the non-AP STA 515. In some examples, a BSS color/APID may correspond to the BSS of the non-AP STA 515 by being equal to at least one BSS color/APID of the BSS/APID of the non-AP STA 515. Additionally, a BSS color/APID may correspond to a BSS in a coordination group associated with the BSS of the non-AP STA 515 by being equal to at least one BSS color/APID of a BSS in a coordination group associated with the BSS of the non-AP STA 515.

In some examples, if one or more of the BSS colors/APIDs indicated in the U-SIG and/or UHR-SIG (e.g., any of the BSS colors/APIDs indicated in the U-SIG and/or UHR-SIG) are different than the BSS color/APID of the AP associated with the non-AP STA 515, then the non-AP STA 515 may trigger switching to the NPCA primary channel (e.g., if NPCA is enabled and one or more switching conditions are met, such as conditions 1) or 2) described in Section 37.10 of 802.11bn). Alternatively, if one or more of the BSS colors/APIDs indicated in the U-SIG and/or UHR-SIG (e.g., any of the BSS colors/APIDs indicated in the U-SIG and/or UHR-SIG) are equal to the BSS color/APID of the AP associated with the non-AP STA 515, then the non-AP STA 515 may not trigger switching to the NPCA primary channel within a shared TXOP.

In some examples, such as examples in which the MAPC scheme includes a Co-TDMA procedure, the BSS color/APID information (e.g., provided at 520) may be carried in an ICF or ICR. The ICF may be a buffer status report poll (BSRP) trigger frame, which may be carried within a common information subfield. The ICR may be a UHR variant MU-BA frame. In some such examples, the ICF or ICR may include other types of information (e.g., in addition to the BSS color/APID information). For example, the ICF or ICR may include a list of BSS colors, which include the BSS color belonging to shared APs (e.g., all the shared APs) that are expected to participate in the TXOP sharing, and may also include the BSS color of the sharing AP. In other words, the ICF or ICR may include a first list of one or more BSS colors, where the first list includes at least a first BSS color corresponding to the APs configured to operate in accordance with the MAPC scheme. Additionally, or alternatively, the ICF or ICR may include a list of BSS colors, which include the BSS color belonging to an OBSS that excludes the BSS color of sharing AP and of the shared APs. In other words, the ICF or ICR may include a second list of one or more BSS colors, where the second list includes at least a second BSS color corresponding to an OBSS, and where the second list excludes at least the first BSS color. Additionally, or alternatively, the ICF or ICR may include a list of APIDs, which include the APID belonging to shared APs (e.g., all the shared APs) that are expected to participate in the TXOP sharing, and may also include the APID of the sharing AP. In other words, the ICF or ICR may include a third list of one or more APIDs, where the third list includes at least a first APID corresponding to at least one of the APs configured to operate in accordance with the MAPC scheme. Additionally, or alternatively, the ICF or ICR may include a list of BSSIDs, which include the BSS ID belonging to shared APs (e.g., all the shared APs) that are expected to participate in the TXOP sharing, and may additionally also include the BSS ID of the sharing AP. In other words, the ICF or ICR may include a fourth list of one or more BSSIDs, where the fourth list includes at least a first BSSID corresponding to the APs configured to operate in accordance with the MAPC scheme.

The information included in the ICF or ICR may be used by one or more non-AP STAs associated with the shared APs to complement the decision on when NPCA switching may occur. For example, non-AP STAs associated with the shared APs may (e.g., are expected to) monitor and decode an ICF or ICR and retrieve the information (e.g., any of the information described above) when the non-AP STAs are NPCA capable and NPCA is enabled. Based on the retrieved information, a STA may switch to NPCA if NPCA is enabled (e.g., if an NPCA operation information present field corresponding to the BSS is equal to 1), if one or more switching conditions are satisfied (e.g., if conditions 1) or 2) described in Section 37.10 of 802.11bn are met), and if the transmission overlapping with the respective BSS primary channel of the STA belongs to a BSS to which neither the sharing AP nor the shared APs belong. In some other examples, the ICF or ICR may carry an additional bit field, which may signal whether NPCA may be enabled or disabled within the group of coordinated BSSs in a shared TXOP. In some examples, based on the information included in the ICF or ICR, a STA receiving either the ICF or ICR may implicitly derive the BSS color/APID to use, and the NPCA rule to apply. That is, the non-AP STA 515 may receive an ICF or ICR including the BSS color/APID information, or other information from which the BSS color/APID information may be derived.

In some other examples, such as examples in which the MAPC scheme includes a Co-BF or Co-SR procedure, the BSS color/APID information (e.g., provided at 520) may be carried in a Co-BF invite, a Co-SR invite, a Co-BF response, a Co-SR response, an ICF, and/or an ICR. For example, the BSS color/APID information may be carried in the Co-BF/Co-SR invite and/or Co-BF/Co-SR response. In such an example, the Co-BF/Co-SR invite and/or the Co-BF/Co-SR response may include other types of information (e.g., in addition to the BSS color/APID information). For example, the Co-BF/Co-SR invite and/or Co-BF/Co-SR response may include the BSS color belonging to the sharing AP, the BSS color(s) belonging to the shared AP(s), the APID belonging to the sharing AP, the APID(s) belonging to the shared AP(s), the BSSID belonging to the sharing AP, and/or the BSSID(s) belonging to the shared AP(s). In other words, the Co-BF/Co-SR invite and/or the Co-BF/Co-SR response may include a first BSS color associated with a first AP sharing the TXOP, a second BSS color associated with a second AP with which the TXOP is shared, a first APID associated with the first AP, a second APID associated with the second AP, a first BSSID associated with the first AP, or a second BSSID associated with the second AP.

The information included in the Co-BF/Co-SR invite and/or the Co-BF/Co-SR response may be used by the non-AP STA(s) to complement the decision on when NPCA switching may occur. For example, non-AP STAs associated with the shared APs may (e.g., are expected to) monitor for co-BF/co-SR invite or response transmission from their associated AP. In such an example, by decoding the content of a co-BF/co-SR invite or response, the non-AP STAs may retrieve some or all of the information described above. Based on the retrieved information, a STA may switch to NPCA if NPCA is enabled (e.g., if an NPCA operation information present field corresponding to the BSS is equal to 1), if one or more switching conditions are satisfied (e.g., if conditions 1) or 2) described in Section 37.10 of 802.11bn are met), and if the transmission overlapping with the respective BSS primary channel of the STA belongs to a BSS to which neither the sharing AP nor the shared APs belong. In some examples, the co-BF/co-SR invite and/or response may carry an additional bit field, which may signal whether NPCA may be enabled or disabled within the group of coordinated BSSs or the associated non-AP STAs in that shared TXOP.

The information included in the ICF or ICR may additionally, or alternatively, be used by one or more non-AP STAs associated with the shared APs to complement the decision on when NPCA switching may occur. For example, non-AP STAs associated with the shared APs may (e.g., are expected to) monitor and decode an ICF or ICR and retrieve the information (e.g., any of the information described above) when the non-AP STAs are NPCA capable and NPCA is enabled. Based on the information retrieved, a STA may switch to NPCA if NPCA is enabled (e.g., if an NPCA operation information present field corresponding to the BSS is equal to 1), if one or more switching conditions are satisfied (e.g., if conditions 1) or 2) described in Section 37.10 of 802.11bn are met), and if the transmission overlapping with the respective BSS primary channel of the STA belongs to a BSS to which neither the sharing AP nor the shared APs belong. In some other examples, the ICF or ICR may carry an additional bit field, which may signal whether NPCA may be enabled or disabled within the group of coordinated BSSs in a shared TXOP.

In some examples, based the information included in a Co-BF invite, Co-SR invite, Co-BF response, Co-SR response, ICF, and/or ICR, a STA receiving the Co-BF invite, Co-SR invite, Co-BF response, Co-SR response, ICF, and/or ICR may implicitly derive the BSS color/APID to use, and the NPCA rule to apply. That is, the non-AP STA 515 may receive a Co-BF invite, Co-SR invite, Co-BF response, Co-SR response, ICF, and/or ICR including the BSS color/APID information, or other information from which the BSS color/APID information may be derived.

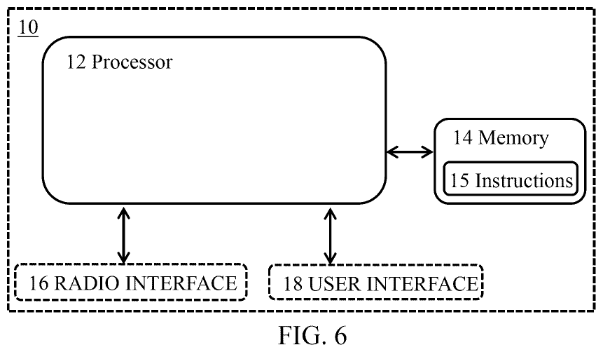

FIG. 6 illustrates an example block diagram of an apparatus 10 to which one or more examples disclosed herein may be applied. The apparatus 10 comprises, for example, at least one processor 12 and at least one memory 14 storing instructions 15 that, when executed by the at least one processor, cause the apparatus 10 at least to perform one or more methods as disclosed herein, and any of the embodiments thereof. In an example, the at least one memory and the instructions (e.g. a computer program code, software), are configured, with the at least one processor, to cause the apparatus 10 to perform one or more methods as disclosed herein, and any of the embodiments thereof.

A processor 12 may comprise circuitry, or be constituted as circuitry or circuitries, the circuitry or circuitries being configured to perform phases of methods in accordance with one or more example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a user equipment, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The memory 14 may be implemented using any suitable data storage technology. The memory may comprise a database for storing data. The memory 14 may be at least in part external to apparatus 10 but accessible to apparatus 10.

The instructions 15 may be comprised in a computer readable medium or a non-transitory computer readable medium. A term non-transitory, as used herein, is a limitation of the medium itself (e.g., tangible, not a signal) as opposed to a limitation on data storage persistency (e.g. random access memory, RAM, vs. read only memory, ROM).

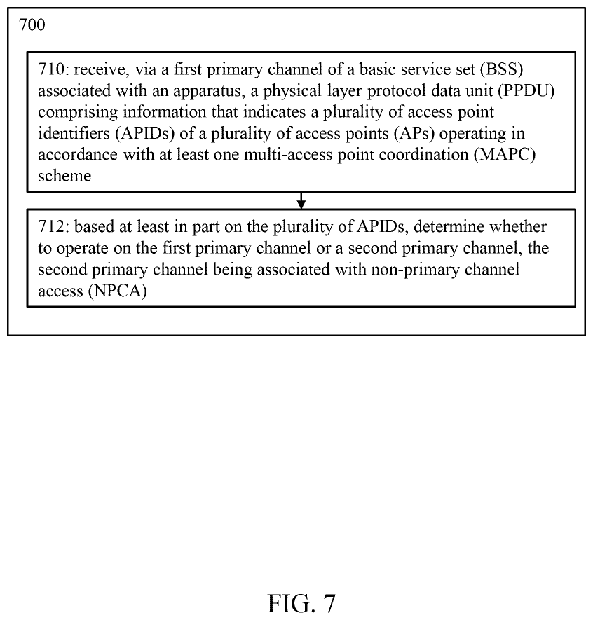

For example, the apparatus 10 may be an AP, such as an AP of FIGS. 1, 2A, 2B, 2C, 2D, 2E, 3, 4, and 5. As another example, the apparatus may be comprised in such an AP, e.g. as a chipset configured to control the AP. The apparatus 10 may be caused or configured to perform at least the method of FIG. 7 and/or any one or more of the embodiments described.

As another example, the apparatus 10 may be a non-AP STA of FIGS. 1, 2A, 2B, 2C, 2D, 2E, 3, 4, and 5. In another example, the apparatus may be comprised in such a STA, e.g. as a chipset configured to control the STA. The apparatus 10 may be caused or configured to perform at least the method of FIG. 7 and/or any one or more of the embodiments described. In some examples, the apparatus 10 may be a UE, or another type of terminal device.

The apparatus may comprise one or more entities of any of protocol layers, such as a MAC entity, a radio resource control (RRC) entity, a radio link control (RLC) entity, a packet data convergence protocol (PDCP) entity or a PHY entity. In at least one embodiment, the entity is configured to perform at least the method of FIG. 7 and/or any one or more of the embodiments described herein.

In some examples, the apparatus 10 may include a radio interface 16. The radio interface 16 may provide the apparatus 10 with communication capabilities. The radio interface 16 may comprise a receiver configured to receive information in accordance with at least one cellular or non-cellular standard. The radio interface 16 may comprise a transmitter configured to transmit information in accordance with at least one cellular or non-cellular standard. The receiver may comprise more than one receiver. The transmitter may comprise more than one transmitter. The radio interface 16 may comprise a transceiver configured to receive and transmit information in accordance with at least one cellular or non-cellular standard. The transceiver may comprise more than one transceiver.

The apparatus 10 may comprise a user interface 18 comprising, for example, at least one of a keypad, a microphone, a touch display, a display, a speaker, etc. The user interface 18 may be used to control the apparatus by the user. The user interface 18 may be external to the apparatus 10. For example, the apparatus 10 may be connected to another device, such as a computer, either via wireless or wired connection, and the apparatus 10 is controlled by the user via the computer.

In some examples, the apparatus 10 may include a transceiver for transmitting and/or receiving signals. The transceiver may be implemented as a single integrated circuit (e.g., using a single application-specific integrated circuit (ASIC) or field-programmable gate array (FPGA)) or as a system-on-a-chip (SOC) that includes different modules for implementing the functionality of the transceiver. The apparatus 10 may also include the at least one processor 12 and/or the at least one memory 14. The at least one processor 12 may be used to execute instructions stored in the at least one memory 14 and/or to store information in the at least one memory 14, for example, such as the results of the executed instructions.

In some examples, the at least one processor 12 may be in communication with the at least one memory 14 via a bus for passing information among components of the apparatus 10. The at least one memory 14 may be non-transitory and may include, for example, one or more volatile and/or non-volatile memories. For example, the at least one memory 14 may be an electronic storage device (e.g., a computer readable storage medium) comprising gates configured to store data (e.g., bits) that may be retrievable by a machine (e.g., a computing device like the processor). The at least one memory 14 may be configured to store information, data, content, applications, instructions, or the like for enabling the apparatus to carry out various functions in accordance with an example embodiment of the present disclosure.

In some examples, the apparatus 10 includes one or more transceivers for transmitting and/or receiving signals, for example, over a backbone and/or over an access interface. A transceiver may be implemented as a single integrated circuit (e.g., using a single ASIC or FPGA) or as a SOC that includes different modules for implementing the functionality of the transceiver. In some examples, the apparatus 10 is implemented in or by a user device to which resources on an access interface may be allocated and assigned.

In some examples, the apparatus 10 is embodied in a chip or chip set. For example, the apparatus 10 may include one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 10 may therefore, in some cases, be configured to implement an embodiment of the present disclosure on a single chip or as a single system on a chip (SOC). As such, in some cases, a chip or chipset may constitute means for performing one or more operations for providing the functionalities described herein.

In some examples, the at least one processor 12 may be embodied in a number of different ways. For example, the at least one processor 12 may be implemented by processing circuitry. For example, the at least one processor 12 may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC, an FPGA, a microcontroller unit (MCU), a hardware accelerator, a special-purpose computer chip, and/or the like. As such, in some embodiments, the at least one processor 12 may include one or more processing cores configured to perform independently. A multi-core processor may enable multiprocessing within a single physical package. Additionally, or alternatively, the at least one processor 12 may include one or more processors configured in tandem via the bus to enable independent execution of instructions, pipelining and/or multithreading.

In an example embodiment, the at least one processor 12 may be configured to execute instructions stored in the at least one memory 14 or otherwise accessible to the at least one processor 12. Alternatively, or additionally, the at least one processor 12 may be configured to execute hard coded functionality. As such, whether configured by hardware or software methods, or by a combination thereof, the at least one processor 12 may represent an entity (e.g., physically embodied in circuitry) capable of performing operations according to an embodiment of the present disclosure while configured accordingly. Thus, for example, when the at least one processor 12 is embodied as an ASIC, FPGA, and/or the like, the at least one processor 12 may be specifically configured hardware for conducting the operations described herein. Alternatively, or additionally, as another example, when the at least one processor 12 is embodied as an executor of instructions, the instructions may specifically configure the processor to perform the algorithms and/or operations described herein when the instructions are executed. However, in some cases, the at least one processor 12 may be a processor of a specific device (e.g., an image or video processing system) configured to employ an embodiment of the present disclosure by further configuration of the processor by instructions for performing the algorithms and/or operations described herein. The at least one processor 12 may include, among other things, a clock, an arithmetic logic unit (ALU), and/or logic gates configured to support operation of the at least one processor 12.

The radio interface 16 (e.g., a communication interface) may be a device and/or circuitry embodied in either hardware or a combination of hardware and software that is configured to receive and/or transmit data, including media content in the form of video or image files, one or more audio tracks, and/or the like. In this regard, the radio interface 16 may include, for example, an antenna (or multiple antennas) and supporting hardware and/or software for enabling communications with a wireless communication network. Additionally, or alternatively, the radio interface 16 may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), USB or other mechanisms.

In some examples, the apparatus 10 may be an AP or a non-AP STA (e.g., such as a client device) usable in a Wi-Fi network capable of operating in accordance with wireless standards (e.g., IEEE 802.11 standards).

In at least one embodiment, at least some of the processes described herein may be carried out by an apparatus comprising means for carrying out at least some of the described processes. Means for performing methods as disclosed herein may include software and/or hardware components of the apparatus 10. For example, the at least one processor 12, the memory 14, and the computer program code form means for carrying out the method or methods as disclosed herein, and any of the embodiments thereof. The term “means” as used in the description and in the claims may refer to one or more individual elements configured to perform the corresponding recited functionality or functionalities, or it may refer to several elements that perform such functionality or functionalities. Furthermore, several functionalities recited in the claims may be performed by the same individual means or the same combination of means. For example, performing such functionality or functionalities may be caused in an apparatus by a processor that executes instructions stored in a memory of the apparatus.

FIG. 7 illustrates an example flowchart 700 of a method to which one or more examples disclosed herein may be applied. The method may be computer-implemented. The method may be performed by a device, such as a STA illustrated by and described with reference to FIGS. 1, 2A, 2B, 2C, 2D, 2E, 3, 4, and 5. In some examples, the STA may be an example of an apparatus 10 illustrated by and described with reference to FIG. 6.

As shown in FIG. 7, the STA, at block 710, receives, via a first primary channel of a BSS associated with an apparatus (e.g., the STA), a PPDU comprising information that indicates a plurality of APIDs of a plurality of APs operating in accordance with at least one MAPC scheme. For example, the STA may include the means (e.g., a processor 12, a memory 14, a radio interface 16) for receiving, via a first primary channel of a BSS associated with the apparatus, a PPDU comprising information that indicates a plurality of APIDs of a plurality of APs operating in accordance with at least one MAPC scheme.

As shown in FIG. 7, the STA, at block 712, based at least in part on the plurality of APIDs, determines whether to operate on the first primary channel or a second primary channel, the second primary channel being associated with NPCA. For example, the STA may include the means (e.g., a processor 12, a memory 14) for, based at least in part on the plurality of APIDs, determining whether to operate on the first primary channel or a second primary channel, the second primary channel being associated with NPCA.

Even though the present disclosure has been described above with reference to an example according to the accompanying drawings, it is clear that the present disclosure is not restricted thereto but can be modified in several ways within the scope of the appended claims. Therefore, all words and expressions should be interpreted broadly, and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. An apparatus, comprising:
at least one processor; and
at least one memory storing instructions that, when executed by the at least one processor, cause the apparatus at least to:
receive, via a first primary channel of a basic service set (BSS) associated with the apparatus, a physical layer protocol data unit (PPDU) comprising information that indicates a plurality of access point identifiers (APIDs) of a plurality of access points (APs) operating in accordance with at least one multi-access point coordination (MAPC) scheme; and
based at least in part on the plurality of APIDs, determine whether to operate on the first primary channel or a second primary channel, the second primary channel being associated with non-primary channel access (NPCA).

2. An apparatus according to claim 1, wherein determining whether to operate on the first primary channel or the second primary channel comprises:
determining to operate on the first primary channel based at least in part on at least one APID of the plurality of APIDs being equal to an APID of an AP associated with the apparatus; or
determining to operate on the second primary channel based at least in part on the plurality of APIDs being different from an APID of an AP associated with the apparatus.

3. An apparatus according to claim 1, wherein the instructions, when executed by the at least one processor, cause the apparatus at least to:
monitor for one or more initial control responses (ICRs) from an AP associated with the apparatus, wherein determining whether to operate on the first primary channel or the second primary channel is based at least in part on the monitoring.

4. An apparatus according to claim 3, wherein the instructions, when executed by the at least one processor, cause the apparatus at least to:
receive, from the AP via the first primary channel, an ICR associated with a transmission opportunity shared between the AP and at least one other AP in accordance with the at least one MAPC scheme; and
determine to continue to operate on the first primary channel within the transmission opportunity based at least in part on the reception of the ICR and at least one APID of the plurality of APIDs being equal to an APID of the AP.

5. An apparatus according to claim 3, wherein the instructions, when executed by the at least one processor, cause the apparatus at least to:
determine to operate on the second primary channel outside of a transmission opportunity based at least in part on a failure to detect an ICR associated with the transmission opportunity and at least one APID of the plurality of APIDs being equal to an APID of the AP, wherein the transmission opportunity is shared between the AP and at least one other AP in accordance with the at least one MAPC scheme.

6. An apparatus according to claim 1, wherein the APID is one of a second plurality of APIDs associated with the AP, and wherein each APID of the second plurality of APIDs is associated with a respective MAPC agreement between the AP and at least one other AP.

7. An apparatus according to claim 1, wherein the apparatus comprises an AP or non-access point (non-AP) station (STA).

8. An apparatus according to claim 7, wherein the AP or non-AP STA is capable of performing one or more NPCA operations.

9. A method, comprising:
receiving, via a first primary channel of a basic service set (BSS) associated with an apparatus, a physical layer protocol data unit (PPDU) comprising information that indicates a plurality of access point identifiers (APIDs) of a plurality of access points (APs) operating in accordance with at least one multi-access point coordination (MAPC) scheme; and
based at least in part on the plurality of APIDs, determining whether to operate on the first primary channel or a second primary channel, the second primary channel being associated with non-primary channel access (NPCA).

10. A method according to claim 9, wherein determining whether to operate on the first primary channel or the second primary channel comprises:
determining to operate on the first primary channel based at least in part on at least one APID of the plurality of APIDs being equal to an APID of an AP associated with the apparatus; or
determining to operate on the second primary channel based at least in part on the plurality of APIDs being different from an APID of an AP associated with the apparatus.

11. A method according to claim 9, wherein the method further comprises:
monitoring for one or more initial control responses (ICRs) from an AP associated with the apparatus, wherein determining whether to operate on the first primary channel or the second primary channel is based at least in part on the monitoring.

12. A method according to claim 11, wherein the method further comprises:
receiving, from the AP via the first primary channel, an ICR associated with a transmission opportunity shared between the AP and at least one other AP in accordance with the at least one MAPC scheme; and
determining to continue to operate on the first primary channel within the transmission opportunity based at least in part on the reception of the ICR and at least one APID of the plurality of APIDs being equal to an APID of the AP.

13. A method according to claim 11, wherein the method further comprises:
determining to operate on the second primary channel outside of a transmission opportunity based at least in part on a failure to detect an ICR associated with the transmission opportunity and at least one APID of the plurality of APIDs being equal to an APID of the AP, wherein the transmission opportunity is shared between the AP and at least one other AP in accordance with the at least one MAPC scheme.

14. A method according to claim 11, wherein the APID is one of a second plurality of APIDs associated with the AP, and wherein each APID of the second plurality of APIDs is associated with a respective MAPC agreement between the AP and at least one other AP.

15. A method according to claim 9, wherein the apparatus comprises an AP or non-access point (non-AP) station (STA).

16. (canceled)

17. A non-transitory computer readable storage medium comprising instructions that, when executed by an apparatus, cause the apparatus at least to:
receive, via a first primary channel of a basic service set (BSS) associated with the apparatus, a physical layer protocol data unit (PPDU) comprising information that indicates a plurality of access point identifiers (APIDs) of a plurality of access points (APs) operating in accordance with at least one multi-access point coordination (MAPC) scheme; and
based at least in part on the plurality of APIDs, determine whether to operate on the first primary channel or a second primary channel, the second primary channel being associated with non-primary channel access (NPCA).

18. A non-transitory computer readable storage medium of claim 17,
wherein determining whether to operate on the first primary channel or the second primary channel comprises:
determining to operate on the first primary channel based at least in part on at least one APID of the plurality of APIDs being equal to an APID of an AP associated with the apparatus; or
determining to operate on the second primary channel based at least in part on the plurality of APIDs being different from an APID of an AP associated with the apparatus.

19. A non-transitory computer readable storage medium of claim 17, wherein the instructions, when executed by the apparatus, cause the apparatus at least to:
monitor for one or more initial control responses (ICRs) from an AP associated with the apparatus, wherein determining whether to operate on the first primary channel or the second primary channel is based at least in part on the monitoring.

20. A non-transitory computer readable storage medium of claim 19, wherein the instructions, when executed by the apparatus, cause the apparatus at least to:
receive, from the AP via the first primary channel, an ICR associated with a transmission opportunity shared between the AP and at least one other AP in accordance with the at least one MAPC scheme; and
determine to continue to operate on the first primary channel within the transmission opportunity based at least in part on the reception of the ICR and at least one APID of the plurality of APIDs being equal to an APID of the AP.

21. A non-transitory computer readable storage medium of claim 19, wherein the instructions, when executed by the apparatus, cause the apparatus at least to:
determine to operate on the second primary channel outside of a transmission opportunity based at least in part on a failure to detect an ICR associated with the transmission opportunity and at least one APID of the plurality of APIDs being equal to an APID of the AP, wherein the transmission opportunity is shared between the AP and at least one other AP in accordance with the at least one MAPC scheme.
